(19) United States
(12) Patent Application Publication
(10) Pub. No.: US 2022/0369647 A1
(43) Pub. Date: Nov. 24, 2022

(54) Microbe-Based Products for Enhancing Growth and Phytocannabinoid Content of Cannabis

(71) Applicant: Locus Agriculture IP Company, LLC, Solon, OH (US)

(72) Inventors: Paul S. ZORNER, Encinitas, CA (US); Sean FARMER, Ft. Lauderdale, FL (US); Ken ALIBEK, Solon, OH (US); Alex FOTSCH, Cardiff, CA (US); Samal IBRAGIMOVA, Solon, OH (US)

(21) Appl. No.: 17/765,555

(22) PCT Filed: Dec. 17, 2020
(86) PCT No.: PCT/US2020/065594

§ 371 Date: Mar. 31, 2022

Related U.S. Application Data
(60) Provisional application No. 62/952,946, filed on Dec. 23, 2019.

(51) Int. Cl. A01N 63/22; A01N 63/38; C09K 17/14

(52) U.S. Cl. CPC A01N 63/22; A01N 63/38; C09K 17/14

(57) ABSTRACT

Compositions and methods are provided for enhancing plant health, growth, yields and/or CBD content of Cannabis plants using a combination of microbes and/or their growth by-products. Specifically, in one embodiment, the subject invention utilizes Trichoderma harzianum and Bacillus amyloliquefaciens NRRL B-67928.

### BACKGROUND OF THE INVENTION

Cannabis is a genus of flowering plants that is used for a wide variety of industrial applications. During the 20th century, it became illegal in most of the world to cultivate or possess Cannabis for sale, and even sometimes for personal use, due to the historic use of Cannabis derivatives as recreational and medicinal psychoactive drugs (e.g., marijuana); however, the market for non-recreational derivatives of Cannabis plants has been rapidly increasing.

There are three species of Cannabis: C. sativa, C. indica and C. ruderalis. Cannabis sativa, also referred to as “hemp” or “industrial hemp,” has typically been grown only for industrial uses, such as, e.g., fiber, textiles, food and nutritional supplements, biodegradable plastics, paper, insulation and biofuel, rather than for drug uses.

All Cannabis plants produce chemicals known as cannabinoids, which are present in a resin within the glandular trichomes that occur on the floral calyxes and bracts of the plants. This resin can also be found in the leaves and stems of hemp plants. Out of over 100 known cannabinoids, one cannabinoid in particular, cannabidiol (CBD), accounts for up to 40% of the plant's extract.

CBD has recently become a popular subject of research due to its potential use for improving anxiety, cognition, insomnia, movement disorders and pain, among other ailments. The compound can be administered to a subject, including humans and animals, in multiple ways, such as inhalation by smoke or vapor, aerosol spray into the cheek, orally, and even topically as a cream or gel.

CBD does not produce the same psychoactivity as tetrahydrocannabinol (THC), which is another well-known cannabinoid and the main psychoactive component in recreational and medicinal marijuana. While hemp does contain THC, the concentration of THC is much lower than other strains of Cannabis, and the concentration of CBD is typically higher. Some governments regulate the concentration of THC in hemp strains and permit only hemp that is bred with particularly low THC content. For example, the hemp legalized for production in the United States is defined as Cannabis plants that have THC levels of 0.3% or lower on a dry weight basis.

A hemp grower will often grow a hemp variety chosen and provided by a contracted CBD, fiber or seed processor. Depending on the variety, a crop will have about 1,500 to 4,000 plants per acre. Hemp plants tend to prefer warm climates with ample sunlight, and only require watering if the soil becomes excessively dry. Hemp does not grow well on wet soils or those with a heavy clay content. Soil with a pH of about 6.0 to 7.0 is preferred.

Given the rapid rate of growth for the hemp industry, and the relatively new regulatory landscape surrounding growing hemp, governments are struggling to keep up with researching and approving agricultural products for use in hemp crops, such as pesticides, fungicides and herbicides.

Nonetheless, hemp can be affected by disease and insect pests in the field, including, for example, gray mold (Botrytis cinerea), white mold (Sclerotinia sclerotiorum), bacterial leaf spots, viruses, and Pythium root rot and blight during establishment. Many of the insects that cause issues with other crops, such as cutworm, grubs, flea beetles, grasshoppers, and aphids, have also been reported in hemp.

Additionally, like any other crop, hemp has specific nutritional needs, including ample amounts of nitrogen and phosphorus, with higher potassium requirements than most crops. Hemp also requires plenty of sulfur and calcium. Thus, fertilization is essential, whether utilizing organic or mineral fertilizers.

Hemp farming is a rapidly growing industry. Additionally, the economic potential for production and processing of hemp derivatives means that the industry will only continue to grow. Thus, materials and methods are needed for enhancing hemp plant production, preferably using environmentally-friendly, organic means.

### BRIEF SUMMARY OF THE INVENTION

The subject invention provides microbe-based products, as well as methods of using these microbe-based products in agricultural applications. Advantageously, the microbe-based products and methods of the subject invention are environmentally-friendly, non-toxic and cost-effective.

In preferred embodiments, the subject invention provides microbe-based soil treatment compositions and methods of their use for enhancing the health, growth, yields and/or phytocannabinoid, including, in some embodiments, cannabadiol (CBD), content of Cannabis plants by, for example, improving the nutrient and moisture retention properties of the rhizosphere. Advantageously, the soil treatment compositions of the subject invention can improve, for example, crop health, as well as crop growth, yields and/or phytocannabinoid content, even in situations where one or more of the plants in a crop are infected with a pathogen or where the immune health of the crop plants is otherwise compromised.

In one embodiment, the subject invention provides soil treatment compositions comprising one or more microorganisms and/or their growth by-products. Also provided are methods of cultivating the microorganisms and/or growth by-products of the soil treatment composition.

In one embodiment, the soil treatment composition comprises a first microorganism and a second microorganism. More specifically, in some embodiments, the first microorganism is a conidia-forming (i.e., spore-forming), non-pathogenic fungal strain, and the second microorganism is a spore-forming, non-pathogenic bacterial strain. Preferably, the composition comprises a Trichoderma spp. fungus and a Bacillus spp. bacterium, although other combinations are envisioned. In a specific embodiment, the composition comprises Trichoderma harzianum and Bacillus amyloliquefaciens.

In one embodiment, the composition can comprise from 1 to 99% Trichoderma by volume and from 99 to 1% Bacillus by volume. In preferred embodiments, the cell count ratio of Trichoderma to Bacillus is about 1:4.

In one embodiment, the microorganisms are selected from other soil-colonizing beneficial microorganisms, such as, for example, nitrogen fixers (e.g., Azotobacter vinelandii), potassium mobilizers (e.g., Frateuria aurantia), and others including, for example, mycorrhizal fungi, Trichoderma guizhouse, Myxococcus xanthus, Pseudomonas chlororaphis, Wickerhamomyces anomalus, Debaryomyces hansenii, Starmerella bombicola, Saccharomyces boulardii, Pichia occidentalis, Pichia kudriavzevii, Meyerozyma aphidis and/or Meyerozyma guilliermondii.

The species and ratio of microorganisms and other ingredients in the composition can be determined according to, for example, the plant being treated, the soil type where the plant is growing, the health of the plant at the time of treatment, as well as other factors. Thus, the composition can be customizable for any given crop.

The microorganisms of the subject soil treatment compositions can be obtained through cultivation processes ranging from small to large scale. These cultivation processes include, but are not limited to, submerged cultivation/fermentation, solid state fermentation (SSF), and modifications, hybrids and/or combinations thereof. In preferred embodiments, the microbes are cultivated using SSF or modifications thereof.

The soil treatment composition can comprise the substrate leftover from fermentation and/or purified or unpurified growth by-products, such as biosurfactants, enzymes and/or other metabolites. The microbes can be live or inactive, although in preferred embodiments, the microbes are live.

The composition is preferably formulated for application to soil, seeds, whole plants, or plant parts (including, but not limited to, roots, tubers, stems, flowers and leaves). In certain embodiments, the composition is formulated as, for example, liquid, dust, granules, microgranules, pellets, wettable powder, flowable powder, emulsions, microcapsules, oils, or aerosols.

To improve or stabilize the effects of the composition, it can be blended with suitable adjuvants and then used as such or after dilution, if necessary. In certain embodiments, the composition is formulated as a concentrated liquid preparation, or as dry powder or dry granules that can be mixed with water and other components to form a liquid product. In one embodiment, the composition comprises the substrate, microbes and growth by-products, blended together and dried to form powder or granules.

In one embodiment, the composition can comprise glucose (e.g., in the form of molasses), glycerol, glycerin, and/or other osmoticum substances, to promote osmotic pressure during storage and transport of the dry product.

In one embodiment, methods are provided for enhancing Cannabis plant health, growth, yields and/or CBD (or other phytocannabinoid) content, wherein one or more soil-colonizing microorganisms and/or growth by-products thereof are contacted with the plant and/or its surrounding environment. The method can be applied to any species of Cannabis, including, for example, C. saliva, C. indica, and/or C. ruderalis. In preferred embodiments, the Cannabis plant is hemp. Even more preferably, the Cannabis is a variety that has been bred to contain a tetrahydrocannabinol (THC) level of 0.3% or less, by dry weight.

The method can comprise contacting a soil treatment composition comprising one or more non-pathogenic, soil-colonizing microorganisms and/or growth by-products thereof with the plant and/or its surrounding environment. In some embodiments, the method comprises applying a first microorganism and a second microorganism, and/or a growth by-product of one or both of these microorganisms, with the plant and/or its surrounding environment. Preferably, the first microorganism is a Trichoderma spp. fungus and the second microorganism is a Bacillus spp. bacterium.

In certain embodiments, the microorganisms of the composition work synergistically with one another to enhance Cannabis health, growth, yields and/or cannabinoid content.

In one embodiment, the method works by enhancing root health and growth. More specifically, in one embodiment, the methods can be used to improve the properties of the rhizosphere in which a plant's roots are growing, for example, the nutrient retention and/or draining properties. Accordingly, the subject methods can also be used for increasing nutrient uptake by plants.

Additionally, in one embodiment, the method can be used to inoculate a plant's rhizosphere with one or more beneficial microorganisms. For example, in preferred embodiments, the microbes of the soil treatment composition can colonize the rhizosphere and provide multiple benefits to a plant whose roots are growing therein, including protection and nourishment.

Advantageously, in certain embodiments, the subject methods can be used to enhance health, growth and/or yields in plants having compromised immune health due to an infection from a pathogenic agent or from an environmental stressor. Thus, in certain embodiments, the subject methods can also be used for improving the immune health, or immune response, of plants.

In certain embodiments, the soil treatment composition is contacted with a plant part. In a specific embodiment, the composition is contacted with one or more roots of the plant. The composition can be applied directly to the roots, e.g., by spraying or dunking the roots, and/or indirectly, e.g., by administering the composition to the soil in which the plant grows (e.g., the rhizosphere). The composition can be applied to the seeds of the plant prior to or at the time of planting, or to any other part of the plant and/or its surrounding environment.

The compositions and methods of the subject invention can be used either alone or in combination with other compounds and/or methods for efficiently enhancing plant health, growth and/or yields, and/or for supplementing the growth of the first and second microbes. For example, in one embodiment, the composition can include and/or can be applied concurrently with nutrients and/or micronutrients for enhancing plant and/or microbe growth, such as magnesium, phosphate, nitrogen, potassium, selenium, calcium, sulfur, iron, copper, and zinc; and/or one or more prebiotics, such as kelp extract, fulvic acid, chitin, humate and/or humic acid. The exact materials and the quantities thereof can be determined by a grower or an agricultural scientist having the benefit of the subject disclosure.

The compositions and methods can also be used in combination with other crop management systems. In one embodiment, the composition can optionally comprise, or be applied with, natural and/or chemical pesticides and/or repellants, such as, for example, any known commercial and/or homemade pesticide that is compatible with the combination of microorganisms being applied. In some embodiments, the composition can also comprise, or be applied with, for example, herbicides, fertilizers, and/or other compatible soil amendments, including commercial products containing nutrient sources (e.g., nitrogen-phosphorous-potassium (NPK) and/or micronutrients).

Advantageously, the present invention can be used without releasing large quantities of inorganic compounds into the environment. Additionally, the compositions and methods utilize components that are biodegradable and toxicologically safe. Even further, the compositions and methods can, in some embodiments, contribute to a reduction in greenhouse gas emissions by, for example, enhancing the sequestration of carbon in soil and plant matter and/or improving fertilization practices. Thus, the present invention can be used as a “green” soil treatment.

### BRIEF DESCRIPTION OF THE FIGURES

FIG. 1 shows early season (6 weeks after planting) vigor of hemp plants that were treated with a composition according to an embodiment of the subject invention, compared to grower's control hemp plants. Treated plants displayed greater width and height, and fuller canopies.

FIG. 2 shows early season (12 weeks after planting) vigor of hemp plants that were treated with a composition according to an embodiment of the subject invention, compared to grower's control hemp plants. Treated plants displayed fuller bud structure and more bud mass.

FIG. 3 shows mid-season vigor of hemp plants located in Green County, N.C., which were treated with a composition according to an embodiment of the subject invention, compared to grower's control hemp plants. Average height, average width, and average number of buds per plant were measured.

FIG. 4 shows root measurements of hemp plants harvested from a plot in Greene County, N.C., which were treated with a composition according to an embodiment of the subject invention, compared to grower's control hemp plants. Average root width, average root depth, and average root weight were measured.

FIG. 5 shows root measurements of hemp plants harvested from a plot in Wake County, N.C., which were treated with a composition according to an embodiment of the subject invention, compared to grower's control hemp plants. Average root width, average root depth, and average root weight were measured.

FIG. 6 shows the roots of hemp plants that were treated with a composition according to an embodiment of the subject invention, compared to grower's control hemp plants. Roots of treated plants are visibly longer and thicker.

FIG. 7 shows nutrient uptake measurements of hemp plants located in a plot in Wake County, N.C., which were treated with a composition according to an embodiment of the subject invention, compared to grower's control hemp plants. Sums of nitrogen uptake, phosphorus uptake, and potassium uptake were measured.

FIGS. 8A-8B show mass of dry material (A) and percentage of CBD (B) collected per acre of hemp plants harvested from a plot in Greene County, N.C., that were treated with a composition according to an embodiment of the subject invention, compared to grower's control hemp plants.

FIGS. 9A-9B show mass of dry material (A) and percentage of CBD (B) collected per acre of hemp plants harvested from a plot in Wake County, N.C., that were treated with a composition according to an embodiment of the subject invention, compared to grower's control hemp plants.

### DETAILED DESCRIPTION OF THE INVENTION

The subject invention provides microbe-based products, as well as methods of using these microbe-based products in agricultural applications. Advantageously, the microbe-based products and methods of the subject invention are environmentally-friendly, non-toxic and cost-effective.

In preferred embodiments, the subject invention provides microbe-based soil treatment compositions and methods of their use for enhancing the health, growth and overall yields of crop plants by, for example, improving the nutrient and moisture retention properties of the rhizosphere. Advantageously, the soil treatment compositions of the subject invention can improve, for example, crop health, as well as crop growth and yields, even in situations where one or more of the plants in a crop are infected with a pathogen or where the immune health of the crop plants is otherwise compromised.

### Selected Definitions

The subject invention utilizes “microbe-based compositions,” meaning a composition that comprises components that were produced as the result of the growth of microorganisms or other cell cultures. Thus, the microbe-based composition may comprise the microbes themselves and/or by-products of microbial growth. The microbes may be in a vegetative state, in spore or conidia form, in hyphae form, in any other form of propagule, or a mixture of these. The microbes may be planktonic or in a biofilm form, or a mixture of both. The by-products of growth may be, for example, metabolites, cell membrane components, expressed proteins, and/or other cellular components. The microbes may be intact or lysed. In preferred embodiments, the microbes are present, with growth medium in which they were grown, in the microbe-based composition. The microbes may be present at, for example, a concentration of at least 1×10⁴, 1×10⁵, 1×10⁶, 1×10⁷, 1×10⁸, 1×10⁹, 1×10¹⁰, 1×10¹¹, 1×10¹² or 1×10¹³ or more CFU per gram or per ml of the composition.

The subject invention further provides “microbe-based products,” which are products that are to be applied in practice to achieve a desired result. The microbe-based product can be simply a microbe-based composition harvested from a microbe cultivation process. Alternatively, the microbe-based product may comprise further ingredients that have been added. These additional ingredients can include, for example, stabilizers, buffers, appropriate carriers, such as water, salt solutions, or any other appropriate carrier, added nutrients to support further microbial growth, non-nutrient growth enhancers and/or agents that facilitate tracking of the microbes and/or the composition in the environment to which it is applied. The microbe-based product may also comprise mixtures of microbe-based compositions. The microbe-based product may also comprise one or more components of a microbe-based composition that have been processed in some way such as, but not limited to, filtering, centrifugation, lysing, drying, purification and the like.

As used herein, “harvested” in the context of fermentation of a microbe-based composition refers to removing some or all of the microbe-based composition from a growth vessel.

As used herein, an “isolated” or “purified” compound is substantially free of other compounds, such as cellular material, with which it is associated in nature. A purified or isolated polynucleotide (ribonucleic acid (RNA) or deoxyribonucleic acid (DNA)) is free of the genes or sequences that flank it in its naturally-occurring state. A purified or isolated polypeptide is free of the amino acids or sequences that flank it in its naturally-occurring state. “Isolated” in the context of a microbial strain means that the strain is removed from the environment in which it exists in nature. Thus, the isolated strain may exist as, for example, a biologically pure culture, or as spores (or other forms of the strain) in association with a carrier.

As used herein, a “biologically pure culture” is a culture that has been isolated from materials with which it is associated in nature. In a preferred embodiment, the culture has been isolated from all other living cells. In further preferred embodiments, the biologically pure culture has advantageous characteristics compared to a culture of the same microbe as it exists in nature. The advantageous characteristics can be, for example, enhanced production of one or more growth by-products.

In certain embodiments, purified compounds are at least 60% by weight the compound of interest. Preferably, the preparation is at least 75%, more preferably at least 90%, and most preferably at least 99%, by weight the compound of interest. For example, a purified compound is one that is at least 90%, 91%, 92%, 93%, 94%, 95%, 98%, 99%, or 100% (w/w) of the desired compound by weight. Purity is measured by any appropriate standard method, for example, by column chromatography, thin layer chromatography, or high-performance liquid chromatography (HPLC) analysis.

A “metabolite” refers to any substance produced by metabolism (e.g., a growth by-product) or a substance necessary for taking part in a particular metabolic process. Examples of metabolites include, but are not limited to, biosurfactants, biopolymers, enzymes, acids, solvents, alcohols, proteins, vitamins, minerals, microelements, and amino acids.

As used herein, “modulate” means to cause an alteration (e.g., increase or decrease).

Ranges provided herein are understood to be shorthand for all of the values within the range. For example, a range of 1 to 20 is understood to include any number, combination of numbers, or sub-range from the group consisting of 1, 2, 3, 4, 5, 6, 7, 8, 9, 10, 11, 12, 13, 14, 15, 16, 17, 18, 19, 20, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

As used herein, “reduce” refers to a negative alteration, and the term “increase” refers to a positive alteration, each of at least 1%, 5%, 10%, 25%, 50%, 75%, or 100%.

As used herein, “reference” refers to a standard or control condition.

As used herein, “surfactant” refers to a compound that lowers the surface tension (or interfacial tension) between two liquids, between a liquid and a gas, or between a liquid and a solid. Surfactants act as, e.g., detergents, wetting agents, emulsifiers, foaming agents, and dispersants. A “biosurfactant” is a surfactant produced by a living organism.

As used herein, “agriculture” means the cultivation and breeding of plants, algae and/or fungi for food, fiber, biofuel, medicines, cosmetics, supplements, ornamental purposes and other uses. According to the subject invention, agriculture can also include horticulture, landscaping, gardening, plant conservation, orcharding and arboriculture. Further included in agriculture are the care, monitoring and maintenance of soil.

As used herein, “crop plants” refer to any species of plant or alga edible by humans or used as a feed for animals or fish or marine animals, or consumed by humans, or used by humans (e.g., textile or cosmetics production), or viewed by humans (e.g., flowers or shrubs in landscaping or gardens) or any plant or alga, or a part thereof, used in industry or commerce or education. In preferred embodiments, the crop plant is a member of the Cannabis genus.

All plants and plant parts can be treated in accordance with the invention. In this context, plants are understood as meaning all plants and plant populations such as desired and undesired wild plants or crop plants (including naturally occurring crop plants). Crop plants can be plants that can be obtained by traditional breeding and optimization methods or by biotechnological and recombinant methods, or combinations of these methods, including the transgenic plants and the plant varieties.

“Plant parts” are understood as meaning all aerial and subterranean parts and organs of the plants such as shoot, leaf, flower and root, examples which may be mentioned being leaves, needles, stalks, stems, flowers, buds, fruit bodies, fruits and seeds, but also roots, tubers and rhizomes. The plant parts also include crop material and vegetative and generative propagation material, for example cuttings, tubers, rhizomes, slips and seeds.

As used herein, “enhancing” means improving or increasing. For example, enhanced plant health means improving the plant's ability grow and thrive (which includes increased seed germination, seedling emergence, and/or vigor), improved ability to withstand transplant shock, improved ability to ward off pests and/or diseases, improved ability to compete with weeds, and improved ability to survive environmental stressors, such as droughts and/or overwatering.

Enhancing plant growth and/or enhanced plant biomass means increasing the size and/or mass of a plant both above and below the ground (e.g., increased canopy/foliar volume, bud size, height, trunk caliper, branch length, shoot length, stalk length, protein content, root size/density and/or overall growth index), and/or improving the ability of the plant to reach a desired size and/or mass.

Enhancing yields mean improving the end products produced by the plants in a crop, for example, by increasing the number and/or size of fruits, leaves, roots, flowers, buds, stalks, seeds, fibers, and/or tubers per plant, and/or improving the quality thereof.

Enhancing CBD (or other cannabinoid) content means increasing the amount of, for example, CBD (or other cannabinoid) extracted from the resin of hemp flowers, leaves and stems (e.g., per unit weight of plant biomass, or per acre of hemp planted).

Advantageously, enhancing Cannabis plant health, growth, yields and/or CBD content according to embodiments of the subject invention can improve the efficiency, increase the output, reduce the cost, and/or reduce the carbon footprint of producing hemp-derived products such as, for example, fibers, textiles, fabric, shoes, ropes, nets, carpets, plastics, papers, building materials, mulch, animal bedding, phytocannabinoid extracts, hemp oil, cooking oil, food products and supplements, soaps, beauty products, health products, balms, serums, moisturizers, seed cakes, protein powders, flours, milk, tea, animal feed, and biofuels.

The term “Cannabis plant(s)” includes wild-type Cannabis sativa and variants thereof, including Cannabis chemovars, which naturally contain different amounts of the individual cannabinoids and also plants that are the result of genetic crosses, self-crosses, or hybrids thereof.

Phytocannabinoids include, but are not limited to, tetrahydrocannabinol (THC) including delta-8-tetrahydrocannabinol (Δ⁸-THC), delta-9-tetrahydrocannabinol (Δ⁹-THC), and/or THC metabolites (e.g., THC-COOH), tetrahydrocannabinolic acid (THCA), cannabidiol (CBD), cannabidiolic acid (CBDA), cannabinol (CBN), cannabigerol (CBG), cannabichromene (CBC), cannabicyclol (CBL), cannabivarin (CBV), tetrahydrocannabivarin (THCV), cannabidivarin (CBDV), cannabichromevarin (CBCV), cannabigerovarin (CBGV), cannabigerol monomethyl ether (CBGM), cannabielsoin (CBE), and cannabicitran (CBT). Other cannabinoids include, for example, pharmaceutically acceptable salts of cannabinoids.

As used herein “preventing” or “prevention” of a situation or occurrence means delaying, inhibiting, suppressing, forestalling, and/or minimizing the onset, extensiveness or progression of the situation or occurrence. Prevention can include, but does not require, indefinite, absolute or complete prevention, meaning the situation or occurrence may still develop at a later time. Prevention can include reducing the severity of the onset of such a situation or occurrence, and/or inhibiting the progression thereof to one that is more severe. As used herein, the term “control” used in reference to a pest means killing, disabling, immobilizing, or reducing population numbers of a pest, or otherwise rendering the pest substantially incapable of reproducing and/or causing harm.

As used herein, a “pest” is any organism, other than a human, that is destructive, deleterious and/or detrimental to humans or human concerns (e.g., agriculture, horticulture). In some, but not all instances, a pest may be a pathogenic organism. Pests may cause or be a vector for infections, infestations and/or disease, or they may simply feed on or cause other physical harm to living tissue. Pests may be single- or multi-cellular organisms, including but not limited to, viruses, fungi, bacteria, protozoa parasites, and/or nematodes. In certain embodiments, weeds or other invasive plants that compete for resources with a plant of interest are also considered pests.

As used herein, a “soil amendment” or a “soil conditioner” is any compound, material, or combination of compounds or materials that are added into soil to enhance the physical properties of the soil. Soil amendments can include organic and inorganic matter, and can further include, for example, fertilizers, pesticides and/or herbicides. Nutrient-rich, well-draining soil is essential for the growth and health of plants, and thus, soil amendments can be used for enhancing the growth and health of plants by altering the nutrient and moisture content of soil. Soil amendments can also be used for improving many different qualities of soil, including but not limited to, soil structure (e.g., preventing compaction); improving the nutrient concentration and storage capabilities; improving water retention in dry soils; and improving drainage in waterlogged soils.

As used herein, “environmental stressor” refers to an abiotic, or non-living, condition that has a negative impact on a living organism in a specific environment. The environmental stressor must influence the environment beyond its normal range of variation to adversely affect the population performance or individual physiology of the organism in a significant way. Examples of environmental stressors include, but are not limited to, drought, extreme temperatures, flood, high winds, natural disasters, soil pH changes, high radiation, compaction of soil, pollution, and others.

The transitional term “comprising,” which is synonymous with “including,” or “containing,” is inclusive or open-ended and does not exclude additional, unrecited elements or method steps. By contrast, the transitional phrase “consisting of” excludes any element, step, or ingredient not specified in the claim. The transitional phrase “consisting essentially of” limits the scope of a claim to the specified materials or steps “and those that do not materially affect the basic and novel characteristic(s)” of the claimed invention. Use of the term “comprising” contemplates other embodiments that “consist” or “consist essentially of” the recited component(s).

Unless specifically stated or obvious from context, as used herein, the term “or” is understood to be inclusive. Unless specifically stated or obvious from context, as used herein, the terms “a,” “and” and “the” are understood to be singular or plural.

Unless specifically stated or obvious from context, as used herein, the term “about” is understood as within a range of normal tolerance in the art, for example within 2 standard deviations of the mean. About can be understood as within 10%, 9%, 8%, 7%, 6%, 5%, 4%, 3%, 2%, 1%, 0.5%, 0.1%, 0.05%, or 0.01% of the stated value.

The recitation of a listing of chemical groups in any definition of a variable herein includes definitions of that variable as any single group or combination of listed groups. The recitation of an embodiment for a variable or aspect herein includes that embodiment as any single embodiment or in combination with any other embodiments or portions thereof.

All references cited herein are hereby incorporated by reference in their entirety.

### Soil Treatment Compositions

In one embodiment, the subject invention provides soil treatment compositions comprising one or more microorganisms and/or their growth by-products. The soil treatment composition can be used to enhance plant health, growth and/or yields. Specifically, the composition can be used to enhance health, growth, yields, and/or CBD content of Cannabis plants.

Advantageously, the compositions according to the subject invention are non-toxic and can be applied in high concentrations without causing irritation to, for example, the skin or digestive tract of a human or other non-pest animal. Thus, the subject invention is particularly useful where application of the soil treatment compositions occurs in the presence of living organisms, such as growers and livestock.

In certain embodiments, the soil treatment composition can comprise one or more non-pathogenic, soil-colonizing microorganisms and/or growth by-products thereof.

In some embodiments, the composition comprises a first microorganism and a second microorganism, wherein, preferably, the first microorganism is a Trichoderma spp. fungus and the second microorganism is a spore-forming Bacillus spp. bacterium, although other combinations are envisioned.

In a specific embodiment, the Trichoderma is T. harzianum and the Bacillus is B. amyloliquefaciens. Even more specifically, in preferred embodiments, the B. amyloliquefaciens is strain NRRL B-67928 (“B. amy”).

A culture of the B. amyloliquefaciens “B. amy” microbe has been deposited with the Agricultural Research Service Northern Regional Research Laboratory (NRRL), 1400 Independence Ave., S.W., Washington, D.C., 20250, USA. The deposit has been assigned accession number NRRL B-67928 by the depository and was deposited on Feb. 26, 2020.

The subject culture has been deposited under conditions that assure that access to the culture will be available during the pendency of this patent application to one determined by the Commissioner of Patents and Trademarks to be entitled thereto under 37 CFR § 1.14 and 35 U.S.C § 122. The deposit is available as required by foreign patent laws in countries wherein counterparts of the subject application, or its progeny, are filed. However, it should be understood that the availability of a deposit does not constitute a license to practice the subject invention in derogation of patent rights granted by governmental action.

Further, the subject culture deposit will be stored and made available to the public in accord with the provisions of the Budapest Treaty for the Deposit of Microorganisms, i.e., it will be stored with all the care necessary to keep it viable and uncontaminated for a period of at least five years after the most recent request for the furnishing of a sample of the deposit, and in any case, for a period of at least 30 (thirty) years after the date of deposit or for the enforceable life of any patent which may issue disclosing the culture. The depositor acknowledges the duty to replace the deposit should the depository be unable to furnish a sample when requested, due to the condition of the deposit. All restrictions on the availability to the public of the subject culture deposit will be irrevocably removed upon the granting of a patent disclosing it.

In one exemplary embodiment, the composition can comprise from 1 to 99% Trichoderma by weight and from 99 to 1% Bacillus by weight. In some embodiments, the cell count ratio of Trichoderma to Bacillus is about 1:9 to about 9:1, about 1:8 to about 8:1, about 1:7 to about 7:1, about 1:6 to about 6:1, about 1:5 to about 5:1 or about 1:4 to about 4:1.

In one exemplary embodiment, the composition comprises about 1×10⁶ to 1×10¹², 1×10⁷ to 1×10¹¹, 1×10⁸ to 1×10¹⁰, or 1×10⁹ CFU/ml of Trichoderma. In one specific embodiment, the composition comprises about 1×10⁶ to 1×10¹², 1×10⁷ to 1×10¹¹, 1×10⁸ to 10¹⁰, or 1×10⁹ CFU/ml of Bacillus.

In some embodiments, the composition comprises one or more other beneficial microorganisms, including bacteria, yeasts and/or fungi. For example, the other microorganisms can be selected from mycorrhizal fungi, Myxococcus xanthus, Azotobacter vinelandii, Frateuria aurantia, Debaryomyces hansenii, Pseudomonas chlororaphis, Trichoderma guizhouse, Wickerhamomyces anomalus, Starmerella bombicola, Saccharomyces boulardii, Pichia occidentalis, Pichia kudriavzevii, Meyerozyma aphidis and/or Meyerozyma guilliermondii, as well as others described elsewhere in this disclosure (e.g., under the heading “Microorganisms”).

In one embodiment, the microorganisms of the subject composition comprise about 5 to 50% of the total composition by weight, or about 8 to 25%, about 10 to 20% or about 12 to 15%. In a specific embodiment, the one or more microbes are present in the composition at a concentration of at least 1×10⁵ to 1×10¹⁰, 1×10⁶ to 1×10¹¹, or 1×10⁷ to 1×10¹² CFU/ml each.

The species and ratio of microorganisms and other ingredients in the composition can be customized according to, for example, the plant being treated, the soil type where the plant is growing, the health of the plant at the time of treatment, as well as other factors.

The microbes and microbe-based compositions of the subject invention have a number of beneficial properties that are useful for enhancing plant health, growth, yields and/or CBD content. For example, the compositions can comprise products resulting from the growth of the microorganisms, such as biosurfactants, proteins and/or enzymes, either in purified or crude form.

In one embodiment, the microorganisms of the subject composition are capable of producing a biosurfactant. In another embodiment, biosurfactants can be produced separately by other microorganisms and added to the composition, either in purified form or in crude form. Crude form biosurfactants can comprise, for example, biosurfactants and other products of cellular growth in the leftover fermentation medium resulting from cultivation of a biosurfactant-producing microbe. This crude form biosurfactant composition can comprise from about 0.001% to about 90%, about 25% to about 75%, about 30% to about 70%, about 35% to about 65%, about 40% to about 60%, about 45% to about 55%, or about 50% pure biosurfactant.

Biosurfactants form an important class of secondary metabolites produced by a variety of microorganisms such as bacteria, fungi, and yeasts. As amphiphilic molecules, microbial biosurfactants reduce the surface and interfacial tensions between the molecules of liquids, solids, and gases. Furthermore, the biosurfactants according to the subject invention are biodegradable, have low toxicity, are effective in solubilizing and degrading insoluble compounds in soil and can be produced using low cost and renewable resources. They can inhibit adhesion of undesirable microorganisms to a variety of surfaces, prevent the formation of biofilms, and can have powerful emulsifying and demulsifying properties. Furthermore, the biosurfactants can also be used to improve wettability and to achieve even solubilization and/or distribution of fertilizers, nutrients, and water in the soil.

Biosurfactants according to the subject methods can be selected from, for example, low molecular weight glycolipids (e.g., sophorolipids, cellobiose lipids, rhamnolipids, mannosylerythritol lipids and trehalose lipids), lipopeptides (e.g., surfactin, iturin, fengycin, arthrofactin and lichenysin), flavolipids, phospholipids (e.g., cardiolipins), and high molecular weight polymers such as lipoproteins, lipopolysaccharide-protein complexes, and polysaccharide-protein-fatty acid complexes.

The composition can comprise one or more biosurfactants at a concentration of 0.001% to 10%, 0.01% to 5%, 0.05% to 2%, and/or from 0.1% to 1%.

Advantageously, in accordance with the subject invention, the soil treatment composition may comprise the medium in which each of the microorganisms were grown. The composition may be, for example, at least, by weight, 1%, 5%, 10%, 25%, 50%, 75%, or 100% growth medium.

The fermentation medium can contain a live and/or an inactive culture, purified or crude form growth by-products, such as biosurfactants, enzymes, and/or other metabolites, and/or any residual nutrients. The amount of biomass in the composition, by weight, may be, for example, anywhere from about 0.01% to 100%, about 1% to 90%, about 5% to about 80%, or about 10% to about 75%.

The product of fermentation may be used directly, with or without extraction or purification. If desired, extraction and purification can be easily achieved using standard extraction and/or purification methods or techniques described in the literature.

The microorganisms in the soil treatment composition may be in an active or inactive form, or in the form of vegetative cells, reproductive spores, mycelia, hyphae, conidia or any other form of microbial propagule. The composition may also contain a combination of any of these microbial forms.

In one embodiment, different species of microorganism are grown separately and then mixed together to produce the soil treatment composition. In one embodiment, microorganisms can be co-cultivated, for example, B. amyloliquefaciens and M xanthus.

In one embodiment, the composition is preferably formulated for application to soil, seeds, whole plants, or plant parts (including, but not limited to, roots, tubers, stems, stalks, buds, flowers and leaves). In certain embodiments, the composition is formulated as, for example, liquid, dust, granules, microgranules, pellets, wettable powder, flowable powder, emulsions, microcapsules, oils, or aerosols.

To improve or stabilize the effects of the composition, it can be blended with suitable adjuvants and then used as such or after dilution, if necessary. In preferred embodiments, the composition is formulated as a liquid, a concentrated liquid, or as dry powder or granules that can be mixed with water and other components to form a liquid product.

In one embodiment, the composition can comprise glucose (e.g., in the form of molasses), glycerol and/or glycerin, as, or in addition to, an osmoticum substance, to promote osmotic pressure during storage and transport of the dry product.

The compositions can be used either alone or in combination with other compounds and/or methods for efficiently enhancing plant health, growth and/or yields, and/or for supplementing the growth of the first and second microbes. For example, in one embodiment, the composition can include and/or can be applied concurrently with nutrients and/or micronutrients for enhancing plant and/or microbe growth, such as magnesium, phosphate, nitrogen, potassium, selenium, calcium, sulfur, iron, copper, and zinc; and/or one or more prebiotics, such as kelp extract, fulvic acid, chitin, humate and/or humic acid. The exact materials and the quantities thereof can be determined by a grower or an agricultural scientist having the benefit of the subject disclosure.

The compositions can also be used in combination with other agricultural compounds and/or crop management systems. In one embodiment, the composition can optionally comprise, or be applied with, for example, natural and/or chemical pesticides, repellants, herbicides, fertilizers, water treatments, non-ionic surfactants and/or soil amendments. Preferably, however, the composition does not comprise and/or is not used with benomyl, dodecyl dimethyl ammonium chloride, hydrogen dioxide/peroxyacetic acid, imazilil, propiconazole, tebuconazole, or trifiumizole.

If the composition is mixed with compatible chemical additives, the chemicals are preferably diluted with water prior to addition of the subject composition.

Further components can be added to the composition, for example, buffering agents, carriers, other microbe-based compositions produced at the same or different facility, viscosity modifiers, preservatives, nutrients for microbe growth, tracking agents, biocides, other microbes, surfactants, emulsifying agents, lubricants, solubility controlling agents, pH adjusting agents, preservatives, stabilizers and ultra-violet light resistant agents.

The pH of the microbe-based composition should be suitable for the microorganism of interest. In a preferred embodiment, the pH of the composition is about 3.5 to 7.0, about 4.0 to 6.5, or about 5.0.

Optionally, the composition can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

The microbe-based compositions may be used without further stabilization, preservation, and storage, however. Advantageously, direct usage of these microbe-based compositions preserves a high viability of the microorganisms, reduces the possibility of contamination from foreign agents and undesirable microorganisms, and maintains the activity of the by-products of microbial growth.

In other embodiments, the composition (microbes, growth medium, or microbes and medium) can be placed in containers of appropriate size, taking into consideration, for example, the intended use, the contemplated method of application, the size of the fermentation vessel, and any mode of transportation from microbe growth facility to the location of use. Thus, the containers into which the microbe-based composition is placed may be, for example, from 1 pint to 1,000 gallons or more. In certain embodiments the containers are 1 gallon, 2 gallons, 5 gallons, 25 gallons, or larger.

### Growth of Microbes According to the Subject Invention

The subject invention utilizes methods for cultivation of microorganisms and production of microbial metabolites and/or other by-products of microbial growth. The subject invention further utilizes cultivation processes that are suitable for cultivation of microorganisms and production of microbial metabolites on a desired scale. These cultivation processes include, but are not limited to, submerged cultivation/fermentation, solid state fermentation (SSF), and modifications, hybrids and/or combinations thereof.

As used herein “fermentation” refers to cultivation or growth of cells under controlled conditions. The growth could be aerobic or anaerobic. In preferred embodiments, the microorganisms are grown using SSF and/or modified versions thereof.

In one embodiment, the subject invention provides materials and methods for the production of biomass (e.g., viable cellular material), extracellular metabolites (e.g. small molecules and excreted proteins), residual nutrients and/or intracellular components (e.g. enzymes and other proteins).

The microbe growth vessel used according to the subject invention can be any fermenter or cultivation reactor for industrial use. In one embodiment, the vessel may have functional controls/sensors or may be connected to functional controls/sensors to measure important factors in the cultivation process, such as pH, oxygen, pressure, temperature, humidity, microbial density and/or metabolite concentration.

In a further embodiment, the vessel may also be able to monitor the growth of microorganisms inside the vessel (e.g., measurement of cell number and growth phases). Alternatively, a daily sample may be taken from the vessel and subjected to enumeration by techniques known in the art, such as dilution plating technique. Dilution plating is a simple technique used to estimate the number of organisms in a sample. The technique can also provide an index by which different environments or treatments can be compared.

In one embodiment, the method includes supplementing the cultivation with a nitrogen source. The nitrogen source can be, for example, potassium nitrate, ammonium nitrate ammonium sulfate, ammonium phosphate, ammonia, urea, and/or ammonium chloride. These nitrogen sources may be used independently or in a combination of two or more.

The method can provide oxygenation to the growing culture. One embodiment utilizes slow motion of air to remove low-oxygen containing air and introduce oxygenated air. In the case of submerged fermentation, the oxygenated air may be ambient air supplemented daily through mechanisms including impellers for mechanical agitation of liquid, and air spargers for supplying bubbles of gas to liquid for dissolution of oxygen into the liquid.

The method can further comprise supplementing the cultivation with a carbon source. The carbon source is typically a carbohydrate, such as glucose, sucrose, lactose, fructose, trehalose, mannose, mannitol, and/or maltose; organic acids such as acetic acid, fumaric acid, citric acid, propionic acid, malic acid, malonic acid, and/or pyruvic acid; alcohols such as ethanol, propanol, butanol, pentanol, hexanol, isobutanol, and/or glycerol; fats and oils such as soybean oil, canola oil, rice bran oil, olive oil, corn oil, sesame oil, and/or linseed oil; etc. These carbon sources may be used independently or in a combination of two or more.

In one embodiment, growth factors and trace nutrients for microorganisms are included in the medium. This is particularly preferred when growing microbes that are incapable of producing all of the vitamins they require. Inorganic nutrients, including trace elements such as iron, zinc, copper, manganese, molybdenum and/or cobalt may also be included in the medium. Furthermore, sources of vitamins, essential amino acids, and microelements can be included, for example, in the form of flours or meals, such as corn flour, or in the form of extracts, such as yeast extract, potato extract, beef extract, soybean extract, banana peel extract, and the like, or in purified forms. Amino acids such as, for example, those useful for biosynthesis of proteins, can also be included.

In one embodiment, inorganic salts may also be included. Usable inorganic salts can be potassium dihydrogen phosphate, dipotassium hydrogen phosphate, disodium hydrogen phosphate, magnesium sulfate, magnesium chloride, iron sulfate, iron chloride, manganese sulfate, manganese chloride, zinc sulfate, lead chloride, copper sulfate, calcium chloride, sodium chloride, calcium carbonate, and/or sodium carbonate. These inorganic salts may be used independently or in a combination of two or more.

In some embodiments, the method for cultivation may further comprise adding additional acids and/or antimicrobials in the medium before, and/or during the cultivation process. Antimicrobial agents or antibiotics are used for protecting the culture against contamination.

Additionally, antifoaming agents may also be added to prevent the formation and/or accumulation of foam during submerged cultivation.

The pH of the mixture should be suitable for the microorganism of interest. Buffers, and pH regulators, such as carbonates and phosphates, may be used to stabilize pH near a preferred value. When metal ions are present in high concentrations, use of a chelating agent in the medium may be necessary.

The microbes can be grown in planktonic form or as biofilm. In the case of biofilm, the vessel may have within it a substrate upon which the microbes can be grown in a biofilm state. The system may also have, for example, the capacity to apply stimuli (such as shear stress) that encourages and/or improves the biofilm growth characteristics.

In one embodiment, the method for cultivation of microorganisms is carried out at about 5° to about 100° C., preferably, 15 to 60° C., more preferably, 25 to 50° C. In a further embodiment, the cultivation may be carried out continuously at a constant temperature. In another embodiment, the cultivation may be subject to changing temperatures.

In one embodiment, the equipment used in the method and cultivation process is sterile. The cultivation equipment such as the reactor/vessel may be separated from, but connected to, a sterilizing unit, e.g., an autoclave. The cultivation equipment may also have a sterilizing unit that sterilizes in situ before starting the inoculation. Air can be sterilized by methods know in the art. For example, the ambient air can pass through at least one filter before being introduced into the vessel. In other embodiments, the medium may be pasteurized or, optionally, no heat at all added, where the use of low water activity and low pH may be exploited to control undesirable bacterial growth.

In one embodiment, the subject invention further provides a method for producing microbial metabolites such as, for example, biosurfactants, enzymes, proteins, ethanol, lactic acid, beta-glucan, peptides, metabolic intermediates, polyunsaturated fatty acid, and lipids, by cultivating a microbe strain of the subject invention under conditions appropriate for growth and metabolite production; and, optionally, purifying the metabolite. The metabolite content produced by the method can be, for example, at least 20%, 30%, 40%, 50%, 60%, 70%, 80%, or 90%.

The microbial growth by-product produced by microorganisms of interest may be retained in the microorganisms or secreted into the growth medium. The medium may contain compounds that stabilize the activity of microbial growth by-product.

The biomass content of the fermentation medium may be, for example, from 5 g/l to 180 g/l or more, or from 10 g/l to 150 g/1.

The cell concentration may be, for example, at least 1×10⁶ to 1×10¹², 1×10⁷ to 1×10¹¹, 1×10⁸ to 1×10¹⁰, or 1×10⁹ CFU/ml.

The method and equipment for cultivation of microorganisms and production of the microbial by-products can be performed in a batch, a quasi-continuous process, or a continuous process.

In one embodiment, all of the microbial cultivation composition is removed upon the completion of the cultivation (e.g., upon, for example, achieving a desired cell density, or density of a specified metabolite). In this batch procedure, an entirely new batch is initiated upon harvesting of the first batch.

In another embodiment, only a portion of the fermentation product is removed at any one time. In this embodiment, biomass with viable cells, spores, conidia, hyphae and/or mycelia remains in the vessel as an inoculant for a new cultivation batch. The composition that is removed can be a cell-free medium or contain cells, spores, or other reproductive propagules, and/or a combination of thereof. In this manner, a quasi-continuous system is created.

Advantageously, the method does not require complicated equipment or high energy consumption. The microorganisms of interest can be cultivated at small or large scale on site and utilized, even being still-mixed with their media.

Advantageously, the microbe-based products can be produced in remote locations. The microbe growth facilities may operate off the grid by utilizing, for example, solar, wind and/or hydroelectric power.

### Microorganisms

The microorganisms useful according to the subject invention can be, for example, non-plant-pathogenic strains of bacteria, yeast and/or fungi. The microbes may be natural or genetically modified microorganisms. For example, the microorganisms may be transformed with specific genes to exhibit specific characteristics. The microorganisms may also be mutants of a desired strain. As used herein, “mutant” means a strain, genetic variant or subtype of a reference microorganism, wherein the mutant has one or more genetic variations (e.g., a point mutation, missense mutation, nonsense mutation, deletion, duplication, frameshift mutation or repeat expansion) as compared to the reference microorganism. Procedures for making mutants are well known in the microbiological art. For example, UV mutagenesis and nitrosoguanidine are used extensively toward this end.

In one embodiment, the microorganisms of the soil treatment composition are “mycorrhizal fungi,” which include any species of fungus that forms a non-parasitic mycorrhizal relationship with a plant's roots. The fungi can be ectomycorrhizal fungi and/or endomycorrhizal fungi, including subtypes thereof (e.g., arbuscular, ericoid, and orchid mycorrhizae).

Non-limiting examples of mycorrhizal fungi according to the subject invention include species belong to Glomeromycota, Basidiomycota, Ascomycota, Zygomycota, Helotiales, and Hymenochaetales, as well as Acaulospora spp. (e.g., A. alpina, A. brasiliensis, A. foveata), Amanita spp. (e.g., A. muscaria, A. phalloides), Amphinema spp. (e.g., A. byssoides, A. diadema, A. rugosum), Astraeus spp. (e.g., A. hygrometricum), Byssocorticium spp. (e.g., B. atrovirens), Byssoporia terrestris (e.g., B. terrestris sartoryi, B. terrestris lilacinorosea, B. terrestris aurantiaca, B. terrestris sublutea, B. terrestris parksii), Cairneyella spp. (e.g., C. variabilis), Cantherellus spp. (e.g., C. cibarius, C. minor, C. cinnabarinus, C. friesii), Cenococcum spp. (e.g., C. geophilum), Ceratobasidium spp. (e.g., C. cornigerum), Cortinarius spp. (e.g., C. austrovenetus, C. caperatus, C. violaceus), Endogone spp. (e.g., E. pisiformis), Entrophospora spp. (e.g., E. colombiana), Funneliformis spp. (e.g., F. mosseae), Gamarada spp. (e.g., G. debralockiae), Gigaspora spp. (e.g., G. gigantean, G. margarita), Glomus spp. (e.g., G. aggregatum, G. brasilianum, G. clarum, G. deserticola, G. etunicatum, G. fasciculatum G. intraradices, G. lamellosum, G. macrocarpum, G. monosporum, G. mosseae, G. versiforme), Gomphidius spp. (e.g., G. glutinosus), Hebeloma spp. (e.g., H. cylindrosporum), Hydnum spp. (e.g., H. repandum), Hymenoscyphus spp. (e.g., H. ericae), Inocybe spp. (e.g., I. bongardii, I. sindonia), Lactarius spp. (e.g., L. hygrophoroides), Lindtneria spp. (e.g., L. brevispora), Melanogaster spp. (e.g., M. ambiguous), Meliniomyces spp. (e.g., M. variabilis), Morchella spp., Mortierella spp. (e.g., M. polycephala), Oidiodendron spp. (e.g., O. maius), Paraglomus spp. (e.g., P. brasilianum), Paxillus spp. (e.g., P. involutus), Penicillium spp. (e.g., P. pinophilum, P. thomili), Peziza spp. (e.g., P. whitei), Pezoloma spp. (e.g., P. ericae); Phlebopus spp. (e.g., P. marginatus), Piloderma spp. (e.g., P. croceum), Pisolithus spp. (e.g., P. tinctorius), Pseudotomentella spp. (e.g., P. tristis), Rhizoctonia spp., Rhizodermea spp. (e.g., R. veluwensis), Rhizophagus spp. (e.g., R. irregularis), Rhizopogon spp. (e.g., R. luteorubescens, R. pseudoroseolus), Rhizoscyphus spp. (e.g., R. ericae), Russula spp. (e.g., R. livescens), Sclerocystis spp. (e.g., S. sinuosum), Scleroderma spp. (e.g., S. cepa, S. verrucosum), Scutellospora spp. (e.g., S. pellucida, S. heterogama), Sebacina spp. (e.g., S. sparassoidea), Setchelliogaster spp. (e.g., S. tenuipes), Suillus spp. (e.g., S. luteus), Thanatephorus spp. (e.g., T. cucumeris), Thelephora spp. (e.g., T terrestris), Tomentella spp. (e.g., T. badia, T. cinereoumbrina, T. erinalis, T. galzinii), Tomentellopsis spp. (e.g., T. echinospora), Trechispora spp. (e.g., T. hymenocystis, T. stellulata, T. thelephora), Trichophaea spp. (e.g., T. abundans, T. woolhopeia), Tulasnella spp. (e.g., T. calospora), and Tylospora spp. (e.g., T. fibrillose).

In certain embodiments, the subject invention utilizes endomycorrhizal fungi, including fungi from the phylum Glomeromycota and the genera Glomus, Gigaspora, Acaulospora, Sclerocystis, and Entrophospora. Examples of endomycorrhizal fungi include, but not are not limited to, Glomus aggregatum, Glomus brasilianum, Glomus clarum, Glomus deserticola, Glomus etunicatum, Glomus fasciculatum, Glomus intraradices (Rhizophagus irregularis), Glomus lamellosum, Glomus macrocarpum, Gigaspora margarita, Glomus monosporum, Glomus mosseae (Funneliformis mosseae), Glomus versiforme, Scutellospora heterogama, and Sclerocystis spp.

In certain embodiments, the microorganisms are yeasts and/or fungi not characterized as mycorrhizal fungi, which include, for example, Aureobasidium (e.g., A. pullulans), Blakeslea, Candida (e.g., C. apicola, C. bombicola, C. nodaensis), Cryptococcus, Debaryomyces (e.g., D. hansenii), Entomophthora, Hanseniaspora, (e.g., H uvarum), Hansenula, Issatchenkia, Kluyveromyces (e.g., K. phaffii), Lentenula edodes, Meyerozyma (e.g., M. aphidis, M. guilliermondii), Phycomyces, Pichia (e.g., P. anomala, P. guilliermondii, P. occidentalis, P. kudriavzevii), Pleurotus (e.g., P. ostreatus), Pseudozyma (e.g., P. aphidis), Saccharomyces (e.g., S. boulardii, S. cerevisiae, S. torula), Starmerella (e.g., S. bombicola), Torulopsis, Trichoderma (e.g., T. reesei, T. harzianum, T. kanenjii, T. guizhouse, T. hamatum, T. viride), Ustilago (e.g., U. maydis), Wickerhamomyces (e.g., W. anomalus), Williopsis (e.g., W. mrakii), Zygosaccharomyces (e.g., Z. bailii), and others. In certain embodiments, the microorganisms are bacteria, including Gram-positive and Gram-negative bacteria. The bacteria may be, for example Agrobacterium (e.g., A. radiobacter), Azotobacter (A. vinelandii, A. chroococcum), Azospirillum (e.g., A. brasiliensis), Bacillus (e.g., B. amyloliquefaciens, B. circulans, B. firmus, B. laterosporus, B. licheniformis, B. megaterium, B. mucilaginosus, B. polymyxa, B. subtilis), Brevibacillus laterosporus, Frateuria (e.g., F. aurantia), Klebsiella, Microbacterium (e.g., M. laevaniformans), myxobacteria (e.g., Myxococcus xanthus, Stignatella aurantiaca, Sorangium cellulosum, Minicystis rosea), Pantoea (e.g., P. agglomerans), Pseudomonas (e.g., P. aeruginosa, P. chlororaphis, P. putida), Rhizobium spp., Rhodospirillum (e.g., R. rubrum), Sphingomonas (e.g., S. paucimobilis), and/or Thiobacillus thiooxidans (Acidothiobacillus thiooxidans).

In an exemplary embodiment, the microorganism is a spore-producing Trichoderma spp. fungus. In a specific preferred embodiment, the microorganism is Trichoderma harzianum or Trichoderma guizhouse. In some embodiments, Trichoderma harzianum is interchangeable with Trichoderma guizhouse.

Certain species of Trichoderma are useful when added to soil, where they can multiply and grow in close association with plants' roots. They are capable of partially protecting the roots from invasion by other plant pathogenic fungi and other microbial and animal pests, in addition to helping to stimulate plant growth.

Trichoderma can establish strong and long-lasting colonization of root surfaces, penetrating into the epidermis and shallow subsurface cells. These root-microorganism associations cause substantial changes to the plant proteome and metabolism. They produce and/or release a variety of compounds that induce localized or systemic resistance responses, causing a lack of pathogenicity to plants.

Additionally, plants are protected from numerous classes of plant pathogen by responses that are similar to systemic acquired resistance and rhizobacteria-induced systemic resistance. Trichoderma spp. can effectively reduce diseases caused by some soil-borne plant pathogens. For example, the species T. harzianum, T hamatum, and T viride have fungicidal activity against Sclerotium, Rhizoctonia, Solani, Pythium, Fusarium, Cercospora, Ralstonia, Fragaria, Rhizopus, Botrytis, Colletotrichum, Magnaporthe, and many others. Moreover, some strains of Trichoderma are able to effectively suppress the growth of some viral and bacterial plant and soil pathogens, as well as produce some significant nematocidal effects.

In addition to protecting plants from pathogens and pests, root colonization by Trichoderma spp. can enhance root growth and development, crop productivity, resistance to abiotic stresses, and bioavailability of nutrients.

In one specific embodiment, the microorganism is Bacillus amyloliquefaciens, such as, for example, the strain B. amyloliquefaciens NRRL B-67928. In some embodiments, the Bacillus microbe can solubilize phosphorus compounds in the soil.

In an exemplary embodiment, Trichoderma harzianum and B. amy work in synergy with one another as one composition towards enhanced plant health, growth, yields and/or CBD content. Trichoderma harzianum is a beneficial fungus that attaches to, and elongates roots, which aids in the increase of nutrient uptake. B. amy is a beneficial rhizobacterium that produces organic acids that help to solubilize and move nutrients, such as NPK, in the soil, ultimately into the rootzone where the plant roots can absorb them. Both of these microbes also produce biosurfactants, which improve water use efficiency and penetration and uptake of water and nutrients through the roots.

In one embodiment, the microorganism is a myxobacterium, or slime-forming bacteria. Specifically, in one embodiment, the myxobacterium is a Myxococcus spp. bacterium, e.g., M. xanthus.

In certain embodiments, the microorganism is one that is capable of fixing and/or solubilizing nitrogen, potassium, phosphorous and/or other micronutrients in soil.

In one embodiment, the microorganism is a nitrogen-fixing microorganism, or a diazotroph, selected from species of, for example, Azospirillum, Azotobacter, Chlorobiaceae, Cyanothece, Frankia, Klebsiella, rhizobia, Meyerozyma, Trichodesmium, and some Archaea. In a specific embodiment, the nitrogen-fixing microorganism is Azotobacter vinelandii.

In another embodiment, the microorganism is a potassium-mobilizing microorganism, or KMB, selected from, for example, Bacillus mucilaginosus, Frateuria aurantia or Glomus mosseae. In a specific embodiment, the potassium-mobilizing microorganism is Frateuria aurantia.

Additional preferred microbes can include, for example, Pseudomonas chlororaphis, Wickerhamomyces anomalus, Debaryomyces hansenii, Starmerella bombicola, Saccharomyces boulardii, Pichia occidentalis, Pichia kudriavzevii, Meyerozyma aphidis and/or Meyerozyma guilliermondii.

In one embodiment, the combination of microorganisms applied to a plant and/or its surrounding environment is customized for a given plant and/or environment. Advantageously, in some embodiments, the combination of microbes works synergistically with one another to enhance plant health, growth and/or yields.

### Preparation of Microbe-Based Products

One microbe-based product of the subject invention is simply the fermentation medium containing the microorganisms and/or the microbial metabolites produced by the microorganisms and/or any residual nutrients. The product of fermentation may be used directly without extraction or purification. If desired, extraction and purification can be easily achieved using standard extraction and/or purification methods or techniques described in the literature.

The microorganisms in the microbe-based products may be in an active or inactive form, or in the form of vegetative cells, reproductive spores, conidia, mycelia, hyphae, or any other form of microbial propagule. The microbe-based products may also contain a combination of any of these forms of a microorganism.

In one embodiment, different strains of microbe are grown separately and then mixed together to produce the microbe-based product. The microbes can, optionally, be blended with the medium in which they are grown and dried prior to mixing.

In one embodiment, the different strains are not mixed together, but are applied to a plant and/or its environment as separate microbe-based products.

The microbe-based products may be used without further stabilization, preservation, and storage. Advantageously, direct usage of these microbe-based products preserves a high viability of the microorganisms, reduces the possibility of contamination from foreign agents and undesirable microorganisms, and maintains the activity of the by-products of microbial growth.

Upon harvesting the microbe-based composition from the growth vessels, further components can be added as the harvested product is placed into containers or otherwise transported for use. The additives can be, for example, buffers, carriers, other microbe-based compositions produced at the same or different facility, viscosity modifiers, preservatives, nutrients for microbe growth, surfactants, emulsifying agents, lubricants, solubility controlling agents, tracking agents, solvents, biocides, antibiotics, pH adjusting agents, chelators, stabilizers, ultra-violet light resistant agents, other microbes and other suitable additives that are customarily used for such preparations.

In one embodiment, buffering agents including organic and amino acids or their salts, can be added. Suitable buffers include citrate, gluconate, tartarate, malate, acetate, lactate, oxalate, aspartate, malonate, glucoheptonate, pyruvate, galactarate, glucarate, tartronate, glutamate, glycine, lysine, glutamine, methionine, cysteine, arginine and a mixture thereof. Phosphoric and phosphorous acids or their salts may also be used. Synthetic buffers are suitable to be used but it is preferable to use natural buffers such as organic and amino acids or their salts listed above.

In a further embodiment, pH adjusting agents include potassium hydroxide, ammonium hydroxide, potassium carbonate or bicarbonate, hydrochloric acid, nitric acid, sulfuric acid or a mixture.

The pH of the microbe-based composition should be suitable for the microorganism(s) of interest. In a preferred embodiment, the pH of the composition is about 3.5 to 7.0, about 4.0 to 6.5, or about 5.0.

In one embodiment, additional components such as an aqueous preparation of a salt, such as sodium bicarbonate or carbonate, sodium sulfate, sodium phosphate, sodium biphosphate, can be included in the formulation.

In certain embodiments, an adherent substance can be added to the composition to prolong the adherence of the product to plant parts. Polymers, such as charged polymers, or polysaccharide-based substances can be used, for example, xanthan gum, guar gum, levan, xylinan, gellan gum, curdlan, pullulan, dextran and others.

In preferred embodiments, commercial grade xanthan gum is used as the adherent. The concentration of the gum should be selected based on the content of the gum in the commercial product. If the xanthan gum is highly pure, then 0.001% (w/v—xanthan gum/solution) is sufficient.

In one embodiment, glucose, glycerol and/or glycerin can be added to the microbe-based product to serve as, for example, an osmoticum during storage and transport. In one embodiment, molasses can be included.

In one embodiment, prebiotics can be added to and/or applied concurrently with the microbe-based product to enhance microbial growth. Suitable prebiotics, include, for example, kelp extract, fulvic acid, chitin, humate and/or humic acid. In a specific embodiment, the amount of prebiotics applied is about 0.1 L/acre to about 0.5 L/acre, or about 0.2 L/acre to about 0.4 L/acre.

Optionally, the product can be stored prior to use. The storage time is preferably short. Thus, the storage time may be less than 60 days, 45 days, 30 days, 20 days, 15 days, 10 days, 7 days, 5 days, 3 days, 2 days, 1 day, or 12 hours. In a preferred embodiment, if live cells are present in the product, the product is stored at a cool temperature such as, for example, less than 20° C., 15° C., 10° C., or 5° C.

Methods of Enhancing Cannabis Health, Growth, Yields, and/or Phytocannabinoid Content

In preferred embodiments, a method is provided for enhancing plant health, growth, yields, and/or CBD content, wherein a combination of beneficial microorganisms, and/or their growth by-products are applied to a plant and/or its surrounding environment. Preferably, the plant is a Cannabis plant. In some embodiments, multiple plants and/or their surrounding environments are treated according to the subject methods.

As used herein, a plant's “surrounding environment” means the soil and/or other medium in which the plant is growing, which can include the rhizosphere. In certain embodiments, the surrounding environment does not extend past, for example, a radius of at least 5 miles, 1 mile, 1,000 feet, 500 feet, 300 feet, 100 feet, 10 feet, 8 feet, or 6 feet from the plant.

In specific embodiments, the methods can comprise applying one or more microorganisms and/or growth by-products thereof to the plant and/or its surrounding environment. In preferred embodiments, the method comprises applying a first microorganism and a second microorganism, and/or a growth by-product of one or both of these microorganisms. Preferably, the first microorganism is a Trichoderma spp. fungus and the second microorganism is a Bacillus spp. bacterium, although other combinations are envisioned. In specific embodiments, the method comprises applying a soil treatment composition according to the subject disclosure to the plant and/or its environment.

In one embodiment, the method comprises cultivating a first and second microorganism separately and then combining them to produce one soil treatment composition. In one embodiment, the first and second microorganisms are not blended together into one product, but are applied to the plant and/or its environment as separate treatments.

To improve or stabilize the effects of the treatment composition, it can be blended with suitable adjuvants and then used as such or after dilution if necessary. In preferred embodiments, the composition is formulated as a dry powder or as granules, which can be mixed with water and other components to form a liquid product.

In one embodiment, multiple microorganisms can be applied contemporaneously with one another, for example, Trichoderma and/or Bacillus can be applied together and/or with one or more additional microorganisms. For example, in addition to the first and second microorganism, a myxobacterium such as Myxococcus xanthus can also be applied, and/or one or more microorganisms capable of fixing, mobilizing and/or solubilizing nitrogen, potassium, phosphorous (or phosphate) and/or other micronutrients in soil. In one embodiment, a nitrogen-fixing microbe, such as, for example, Azotobacter vinelandii, can also be applied. In another embodiment, a potassium-mobilizing microbe, such as, for example, Frateuria aurantia can also be applied.

In some embodiments, the methods further comprise applying materials with the composition to enhance microbe growth during application (e.g., nutrients and/or prebiotics to promote microbial growth). In one embodiment, nutrient sources can include, for example, sources of nitrogen, potassium, phosphorus, magnesium, proteins, vitamins and/or carbon. In one embodiment, prebiotics can include, for example, kelp extract, fulvic acid, chitin, humate and/or humic acid.

In one embodiment, the method works by enhancing root health and growth. More specifically, in one embodiment, the methods can be used to improve the properties of the rhizosphere in which a plant's roots are growing, for example, the nutrient and/or moisture retention properties. Accordingly, the methods can also be used for increasing nutrient uptake by plants.

Additionally, in one embodiment, the method can be used to inoculate a rhizosphere with one or more beneficial microorganisms. For example, in preferred embodiments, the microbes of the soil treatment composition can colonize the rhizosphere and provide multiple benefits to the plant whose roots are growing therein, including protection and nourishment.

Advantageously, in one embodiment, the subject methods can be used to enhance health, growth, yields and/or CBD content in plants having compromised immune health due to an infection from a pathogenic agent or from an environmental stressor, such as, for example, drought. Thus, in certain embodiments, the subject methods can also be used for improving the immune health, or immune response, of plants.

As used herein, “applying” a composition or product refers to contacting a composition or product with a target or site such that the composition or product can have an effect on that target or site. The effect can be due to, for example, microbial growth and/or interaction with a plant, as well as the action of a metabolite, enzyme, biosurfactant or other microbial growth by-product. Applying can also include “treating” a target or site with a composition.

Application can further include contacting the microbe-based product directly with a plant, plant part, and/or the plant's surrounding environment (e.g., the soil or the rhizosphere). The microbe-product can be applied as a seed treatment or to the soil surface, or to the surface of a plant or plant part (e.g., to the surface of the roots, tubers, stems, flowers, leaves, fruit, or flowers). It can be sprayed, poured, sprinkled, injected or spread as liquid, dry powder, dust, granules, microgranules, pellets, wettable powder, flowable powder, emulsions, microcapsules, oils, gels, pastes or aerosols. In a specific embodiment, the composition is contacted with one or more roots of the plant.

The composition can be applied directly to the roots, e.g., by spraying or dunking the roots, and/or indirectly, e.g., by administering the composition to the soil in which the plant grows (e.g., the rhizosphere). The composition can be applied to the seeds of the plant prior to or at the time of planting, or to any other part of the plant and/or its surrounding environment.

In certain embodiments, the compositions provided herein are applied to the soils surface without mechanical incorporation. The beneficial effect of the soil application can be activated by rainfall, sprinkler, flood, or drip irrigation, and subsequently delivered to, for example, the roots of plants.

Plants and/or their environments can be treated at any point during the process of cultivating the plant. For example, the soil treatment composition can be applied to the soil prior to, concurrently with, or after the time when seeds are planted therein. It can also be applied at any point thereafter during the development and growth of the plant, including when the plant is flowering, fruiting, and during and/or after abscission of leaves.

In one embodiment, the method can be used in a large scale agricultural setting. The method can comprise administering the soil treatment composition into a tank connected to an irrigation system used for supplying water, fertilizers or other liquid compositions to a crop, orchard or field. Thus, the plant and/or soil surrounding the plant can be treated with the soil treatment composition via, for example, soil injection, soil drenching, or using a center pivot irrigation system, or with a spray over the seed furrow, or with sprinklers or drip irrigators. Advantageously, the method is suitable for treating hundreds of acres of crops, orchards or fields at one time.

In one embodiment, the method can be used in a smaller scale setting, such as in a home garden or greenhouse. In such cases, the method can comprise spraying a plant and/or its surrounding environment with the soil treatment composition using a handheld lawn and garden sprayer. The composition can be mixed with water, and optionally, other lawn and garden treatments, such as fertilizers and pesticides. The composition can also be mixed in a standard handheld watering can and poured onto soil.

In one embodiment, the subject invention can also be used for improving one or more qualities of soil, thereby enhancing the performance of the soils for agricultural, home and gardening purposes.

In certain embodiments, the soil treatment composition may also be applied so as to promote colonization of the roots and/or rhizosphere as well as the vascular system of the plant in order to enhance plant health and vitality. Thus, nutrient-fixing microbes such as Rhizobium and/or Mycorrhizae can be promoted, as well as other beneficial endogenous and exogenous microbes, and/or their by-products that promote crop growth, health and/or yield.

In one embodiment, the method can be used for enhancing penetration of beneficial molecules through the outer layers of root cells.

The subject invention can be used to improve any number of qualities in any type of soil, for example, clay, sandy, silty, peaty, chalky, loam soil, and/or combinations thereof. Furthermore, the methods and compositions can be used for improving the quality of dry, waterlogged, porous, depleted, compacted soils and/or combinations thereof.

In one embodiment, the method can be used for improving the drainage and/or dispersal of water in waterlogged soils. In one embodiment, the method can be used for improving water retention in dry soil.

In one embodiment, the method can be used for improving nutrient retention in porous and/or depleted soils.

In one embodiment, the method controls pathogenic bacteria themselves. In one embodiment, the method works by enhancing the immune health of plants to increase the ability to fight off infections.

In yet another embodiment, the method controls pests that might act as vectors or carriers for pathogenic bacteria, such as flies, aphids, ants, beetles, and whiteflies. Thus, the subject methods can prevent the spread of plant pathogenic bacteria by controlling, e.g., killing, these carrier pests.

The microbe-based products can be used either alone or in combination with other compounds for efficient enhancement of plant health, growth and/or yields, as well as other compounds for efficient treatment and prevention of plant pathogenic pests. For example, the methods can be used concurrently with sources of nutrients and/or micronutrients for enhancing plant and/or microbe growth, such as magnesium, phosphate, nitrogen, potassium, selenium, calcium, sulfur, iron, copper, and zinc; and/or one or more prebiotics, such as kelp extract, fulvic acid, chitin, humate and/or humic acid. The exact materials and the quantities thereof can be determined by a grower or an agricultural scientist having the benefit of the subject disclosure.

The compositions can also be used in combination with other agricultural compounds and/or crop management systems. In one embodiment, the composition can optionally comprise, and/or be applied with, for example, natural and/or chemical pesticides, repellants, herbicides, fertilizers, water treatments, non-ionic surfactants and/or soil amendments.

In one embodiment, the subject compositions are compatible for use with agricultural compounds characterized as antiscalants, such as, e.g., hydroxyethylidene diphosphonic acid;

bactericides, such as, e.g., streptomycin sulfate and/or Galltrol® (A. radiobacter strain K84);

biocides, such as, e.g., chlorine dioxide, didecyldimethyl ammonium chloride, halogenated heterocyclic, and/or hydrogen dioxide/peroxyacetic acid;

fertilizers, such as, e.g., N-P-K fertilizers, calcium ammonium nitrate 17-0-0, potassium thiosulfate, nitrogen (e.g., 10-34-0, Kugler KQ-XRN, Kugler KS-178C, Kugler KS-2075, Kugler LS 6-24-6S, UN 28, UN 32), and/or potassium;

fungicides, such as, e.g., chlorothalonil, manicozeb hexamethylenetetramine, aluminum tris, azoxystrobin, Bacillus spp. (e.g., B. licheniformis strain 3086, B. subtilis, B. subtilis strain QST 713), benomyl, boscalid, pyraclostrobin, captan, carboxin, chloroneb, chlorothalonil, copper culfate, cyazofamid, dicloran, dimethomorph, etridiazole, thiophanate-methyl, fenamidone, fenarimol, fludioxonil, fluopicolide, flutolanil, iprodione, mancozeb, maneb, mefanoxam, fludioxonil, mefenoxam, metalaxyl, myclobutanil, oxathiapiprol in, pentachloronitrobenzene (quintozene), phosphorus acid, propamocarb, propanil, pyraclostrobin, Reynoutria sachalinensis, Streptomyces spp. (e.g., S. griseoviridis strain K61, S. lydicus WYEC 108), sulfur, urea, thiabendazole, thiophanate methyl, thiram, triadimefon, triadimenol, and/or vinclozolin;

growth regulators, such as, e.g., ancymidol, chlormequat chloride, diaminozide, paclobutrazol, and/or uniconazole;

herbicides, such as, e.g., glyphosate, oxyfluorfen, and/or pendimethalin;

insecticides, such as, e.g., acephate, azadirachtin, B. thuringiensis (e.g., subsp. israelensis strain AM 65-52), Beauveria bassiana (e.g., strain GI-IA), carbaryl, chlorpyrifos, cyantraniliprole, cyromazine, dicofol, diazinon, dinotefuran, imidacloprid, Isaria fumosorosae (e.g., Apopka strain 97), lindane, and/or malathion;

water treatments, such as, e.g., hydrogen peroxide (30-35%), phosphonic acid (5-20%), and/or sodium chlorite;

as well as glycolipids, lipopeptides, deet, diatomaceous earth, citronella, essential oils, mineral oils, garlic extract, chili extract, and/or any known commercial and/or homemade pesticide that is determined to be compatible by the skilled artisan having the benefit of the subject disclosure.

Preferably, the composition does not comprise and/or is not applied simultaneously with, or within 7 to 10 days before or after, application of the following compounds: benomyl, dodecyl dimethyl ammonium chloride, hydrogen dioxide/peroxyacetic acid, imazilil, propiconazole, tebuconazole, or trifiumizole.

In certain embodiments, the compositions and methods can be used to enhance the effectiveness of other compounds, for example, by enhancing the penetration of a pesticidal compound into a plant or pest, or enhancing the bioavailability of a nutrient to plant roots. The microbe-based products can also be used to supplement other treatments, for example, antibiotic treatments. Advantageously, the subject invention helps reduce the amount of antibiotics that must be administered to a crop or plant in order to be effective at treating and/or preventing bacterial infection.

In one embodiment, the methods and compositions according to the subject invention lead to an increase in one or more of: root mass, stalk diameter, plant height, canopy density, chlorophyll content, flower count, bud count, bud size, bud density, leaf surface area, protein content, fibrous material and/or nutrient uptake of a plant, by at least 1%, 5%, 10%, 20%, 30%, 40%, 50%, 60% 70%, 80%, 90%, 100%, 150%, 200%, or more, compared to a plant growing in an untreated environment.

In certain embodiments, the methods and compositions according to the subject invention lead to an increase in crop yield (e.g., increased bud number, increased fibrous material, increased seed count, increased overall dry material, increased CBD content) by at least 1% 5%, 10%, 20%, 30%, 40%, 50%, 60% 70%, 80%, 90%, 100%, 150%, 200%, or more, compared to untreated crops.

In one embodiment, the methods and compositions according to the subject invention lead to a reduction in the number of pests on a plant or in a plant's surrounding environment by at least 1%, 5%, 10%, 20%, 30%, 40%, 50%, 60% 70%, 80%, 90%, 100%, 150%, 200%, or more, compared to a plant growing in an untreated environment.

In one embodiment, the methods and compositions according to the subject invention reduce damage to a plant caused by pests by about 5%, 10%, 20%, 30%, 40%, 50%, 60% 70%, 80%, 90%, 100%, 150%, 200%, or more, compared to plants growing in an untreated environment.

Advantageously, the subject invention is useful for improving and/or increasing the production of industrial hemp products for use in a variety of industries, including but not limited to the following examples. Fiber derived from hemp plant material are used by the textile industry for producing fabric, shoes, ropes, nets, and carpets, as well as for producing plastics, papers and other building materials. Hemp leaves can be used for mulch, composting, and animal bedding, as well as for extraction of CBD and other cannabinoids. Hemp oil, which comprises CBD, can be used as a cooking oil, a food supplement, and in soap, beauty products, health products, balms, serums and moisturizers. CBD extracts can also be used for producing health, wellness and beauty products. Hemp seeds can be used for producing seed cakes, protein powders, flours, milk, tea, and where legal, animal feed. Even further, hemp can be used as a biofuel.

### Greenhouse Gas Reduction

In one embodiment, the methods can be useful for reducing atmospheric greenhouse gases (e.g., carbon dioxide, methane, nitrous oxide, and precursors thereof), including those produced as a result of agricultural practices and/or production of hemp. This can be achieved by, for example, enhancing vegetative carbon utilization and storage in crops, increasing carbon sequestration in soil, reducing soil GHG emissions, improving agricultural nitrogen-based fertilization practices, improving biodiversity in soil microbiota, and improving agricultural soil management.

In certain embodiments, enhanced vegetative carbon utilization and/or storage can be in the form of, for example, increased foliage in plants, increased stem and/or trunk diameter, enhanced root growth, and/or increased numbers of plants per unit of area.

In certain embodiments, increased soil carbon sequestration can be in the form of, for example, increased growth of plant roots (e.g., length and density), increased uptake by microorganisms of GHG precursors/organic compounds secreted by plants (including secretions from plant roots), and increased microbial colonization of soil (leading to increased soil microbial biomass).

In some embodiments, reducing soil GHG emissions includes reducing the amount of methane, carbon dioxide, and/or nitrous oxide/precursors thereof emitted from soil. For example, in some embodiments, this can be achieved through reduction of water stress and/or increase in water use efficiency of plants. Ample soil moisture leads to, for example, reduced soil temperature and increased nutrient transport to plants, both of which contribute to reduced soil respiration leading to GHG emissions and reduced free GHG precursor molecules in soil. Additionally, in some exemplary embodiments, the methods can facilitate water movement through soil, which prevents flooding and pooling of water that can lead to deoxygenation of soils and encourage growth of anaerobic methanogenic microbes.

In certain embodiments, improved agricultural fertilization practices, improved soil biodiversity, and/or improved soil management can be in the form of inoculating a plant's rhizosphere with one or more beneficial microorganisms. For example, in preferred embodiments, the microbes of the soil treatment composition can colonize the rhizosphere and provide multiple benefits to a plant whose roots are growing therein, including protection, hydration and nourishment. Thus, the methods can replace or reduce the use of nitrogen-rich fertilizers, pesticides, and/or other soil amendments that produce nitrous oxide precursors, such as nitrogen and ammonia.

Advantageously, in some embodiments, the methods can be used for producing reduced-carbon footprint hemp-based products, including products in the food, drink, textile, wellness, cosmetics and construction industries, e.g., hemp seeds, hemp protein powders, hemp milk, hemp tea, plastic alternatives, paper, clothing, shoes, fabrics, ropes, nets, and carpets, lotions, balms, makeup, hair care products, cleansers, serums, animal feeds, CBD-based health and wellness products, animal bedding, biofuels, and many more.

### EXAMPLES

A greater understanding of the present invention and of its many advantages may be had from the following examples, given by way of illustration. The following examples are illustrative of some of the methods, applications, embodiments and variants of the present invention. They are not to be considered as limiting the invention.

### Example 1—Solid State Fermentation of Bacillus Microbes

For Bacillus spp. spore production, a wheat bran-based media is used. The media is spread onto stainless steel pans in a layer about 1 to 2 inches think and sterilized.

Following sterilization, the pans are inoculated with seed culture. Optionally, added nutrients can be included to enhance microbial growth, including, for example, salts and/or carbon sources such as molasses, starches, glucose and sucrose. To increase the speed of growth and increase the motility and distribution of the bacteria throughout the culture medium, potato extract or banana peel extract can be added to the culture.

Spores of the Bacillus strain of choice are then sprayed or pipetted onto the surface of the substrate and the trays are incubated between 32-40° C. Ambient air is pumped through the oven to stabilize the temperature. Incubation for 48-72 hours can produce 1×10¹⁰ spores/gram or more of the strain.

### Example 2—Solid State Fermentation of Fungal Spores

For growing Trichoderma spp., 250 g of nixtamilized corn flour is mixed with deionized water and sterilized in a stainless steel pan, sealed with a lid and pan bands. The corn flour medium is aseptically inoculated with Trichoderma seed culture by spraying or pipetting. The pans are then incubated at 30° C. for 10 days. After 10 days, approximately 10⁹ propagules/gram or more of Trichoderma can be harvested. Trichoderma propagules (conidia and/or hyphae) harvested from one batch can treat, for example, 1,000 to 2,000 acres of land.

### Example 3—Preparation of Microbe-Based Product

The microbes, substrate, and any residual nutrients that result from production using the methods described in Examples 1 and 2 can be blended and/or micronized and dried to form granules or a powder substance. Different strains of microbe are produced separately and then mixed together either before or after drying.

A sealable pouch can be used to store and transport a product containing a mixture of 10⁹ cells/g of T harzianum and 10¹⁰ cells/g of B. amyloliquefaciens. Micronutrients, or other microbes similarly produced, can be added to the product.

To prepare for use, the dry product is dissolved in water. The concentration can reach at least 5×10⁹ to 5×10¹⁰ cells/ml. The product is then diluted with water in a mixing tank to a concentration of 1×10⁶ to 1×10⁷ cells/ml.

One bag can be used to treat approximately 20 acres of crop, or 10 acres of citrus grove.

The composition can be mixed with and/or applied concurrently with additional “starter” materials to promote initial growth of the microorganisms in the composition. These can include, for example, prebiotics and/or nano-fertilizers (e.g., Aqua-Yield, NanoGro™).

One exemplary formulation of a starter composition comprises:
Soluble potash (K2O) (1.0% to 2.5%, or about 2.0%)
Magnesium (Mg) (0.25% to 0.75%, or about 0.5%)
Sulfur (S) (2.5% to 3.0%, or about 2.7%)
Boron (B) (0.01% to 0.05%, or about 0.02%)
Iron (Fe) (0.25% to 0.75%, or about 0.5%)
Manganese (Mn) (0.25% to 0.75%, or about 0.5%)
Zinc (Zn) (0.25% to 0.75%, or about 0.5%)
Humic acid (8% to 12%, or about 10%)
Kelp extract (5% to 10%, or about 6%)
Water (70% to 85%, or about 77% to 80%).

The microbial inoculant, and/or optional growth-promoting “starter” materials, are mixed with water in an irrigation system tank and applied to soil.

### Example 4—Microbial Strains

The subject invention utilizes beneficial microbial strains. Trichoderma harzianum strains can include, but are not limited to, T-315 (ATCC 20671); T-35 (ATCC 20691); 1295-7 (ATCC 20846); 1295-22 [T-22] (ATCC 20847); 1295-74 (ATCC 20848); 1295-106 (ATCC 20873); T12 (ATCC 56678); WT-6 (ATCC 52443): Rifa T-77 (CMI CC 333646); T-95 (60850); T12m (ATCC 20737); SK-55 (No. 13327; BP 4326 NIBH (Japan)); RR17Bc (ATCC PTA 9708); TSHTH20-1 (ATCC PTA 10317); AB 63-3 (ATCC 18647); OMZ 779 (ATCC 201359); WC 47695 (ATCC 201575); m5 (ATCC 201645); (ATCC 204065); UPM-29 (ATCC 204075); T-39 (EPA 119200); F11Bab (ATCC PTA 9709); and/or Trichoderma guizhouse.

Bacillus amyloliquefaciens strains can include, but are not limited to, NRRL B-67928, FZB24 (EPA 72098-5; BGSC 10A6), TA208, NJN-6, N2-4, N3-8, and those having ATCC accession numbers 23842, 23844, 23843, 23845, 23350 (strain DSM 7), 27505, 31592, 49763, 53495, 700385, BAA-390, PTA-7544, PTA-7545, PTA-7546, PTA-7549, PTA-7791, PTA-5819, PTA-7542, PTA-7790, and/or PTA-7541.

### Examples—North Carolina Field Trials

A plot in Greene County, N.C. and a plot in Wake County, N.C. were each planted with industrial hemp clones. Each plot was divided in half by treatment, where one half was treated once at transplant with 3 oz./acre of a composition according to embodiments of the subject invention (e.g., a composition as described in Example 3 above), and the other half was not treated with the composition (grower's practice control).

Overall, growth qualities and vigor remained fairly similar between both plots throughout the growing season; however, at harvest, increases in root structure, yield, and CBD content were observed within the treated portions, as compared to the control portions.

### Vigor

Vigor is the expression of a plant's response to its environment, including, for example, water supply, nutrition, temperature, and soil type. A vigorous plant responds positively to its environments, which can be exhibited by, for example, plant growth. A vigorous plant is also able to withstand weed pressure and competition for resources from surrounding plants.

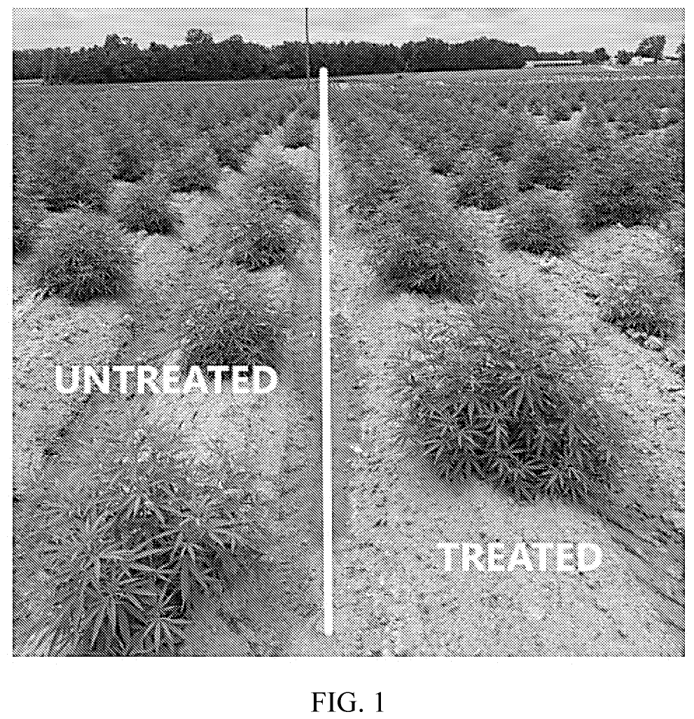

FIG. 1 shows early season (6 weeks after planting) vigor of treated hemp plants compared to grower's control hemp plants. Treated plants displayed increased overall vigor, as shown by their visibly greater width and height, and their fuller canopies.

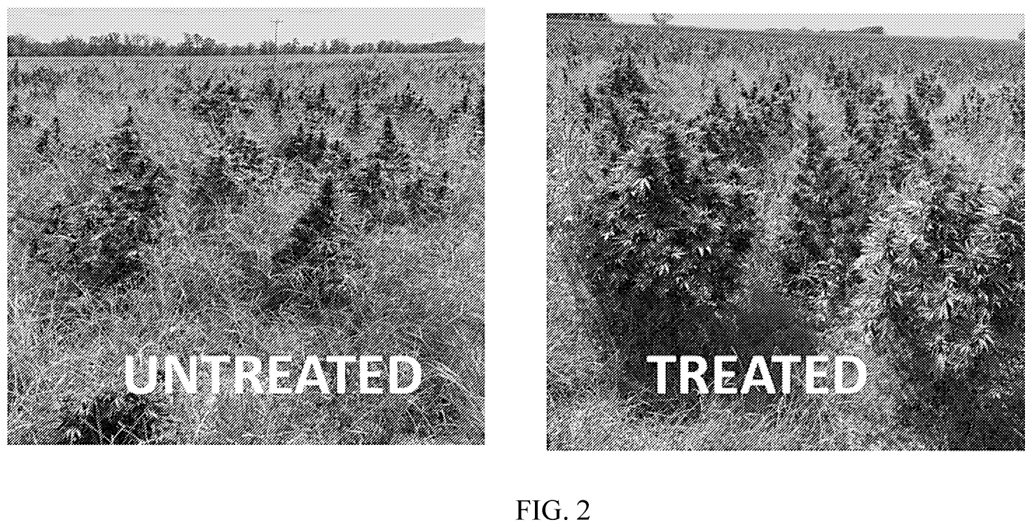

FIG. 2 shows early season (12 weeks after planting) vigor of treated hemp plants compared to grower's control hemp plants. Treated plants displayed fuller, longer bud structure, more bud mass, and overall increased bud density, which leads to more expected harvestable bud material.

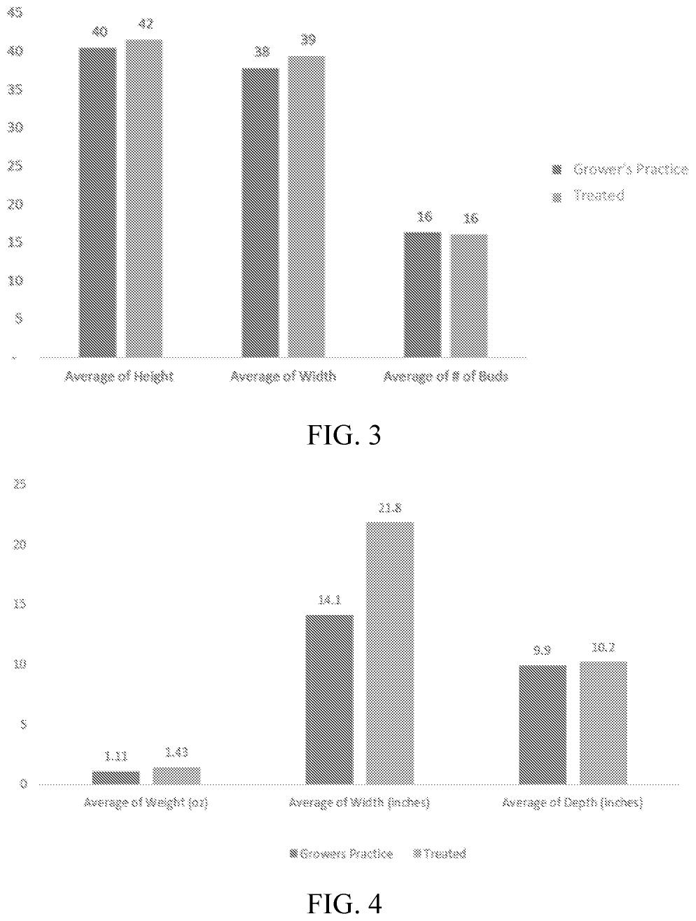

FIG. 3 shows mid-season vigor of treated hemp plants in the Greene County plot, compared to grower's control hemp plants. A 5% increase in average plant height and a 2.63% increase in plant width were observed in the treated hemp over the untreated. No increase in bud number was observed.

### Root Growth at Harvest

Hemp is often grown from cloned transplants to, for example, ensure compliance with governmental regulations. These clones often lack a traditional taproot system.

FIG. 4 shows root measurements of treated hemp plants harvested from the Greene County plot, compared to grower's control hemp plants. A 28.83% increase in average root weight, a 54.61% increase in average root width, and a 3.03% increase in average root depth were observed in the treated hemp over the untreated.

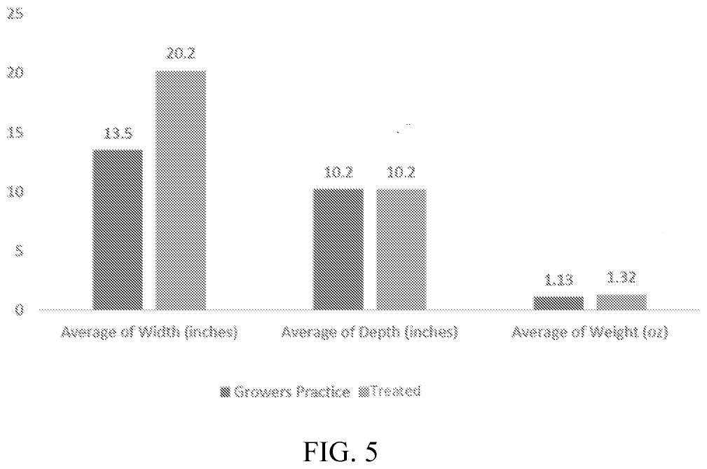

FIG. 5 shows root measurements of treated hemp plants harvested from the Wake County plot, compared to grower's control hemp plants. A 49.63% increase in average root width and a 16.81% increase in average root weight were observed in the treated hemp over the untreated. Average root depth was unchanged, meaning that root growth occurred laterally. Lateral growth and increased root mass of fibrous roots allows for increased nutrient uptake, better drought tolerance, and a sturdier base for plant stability.

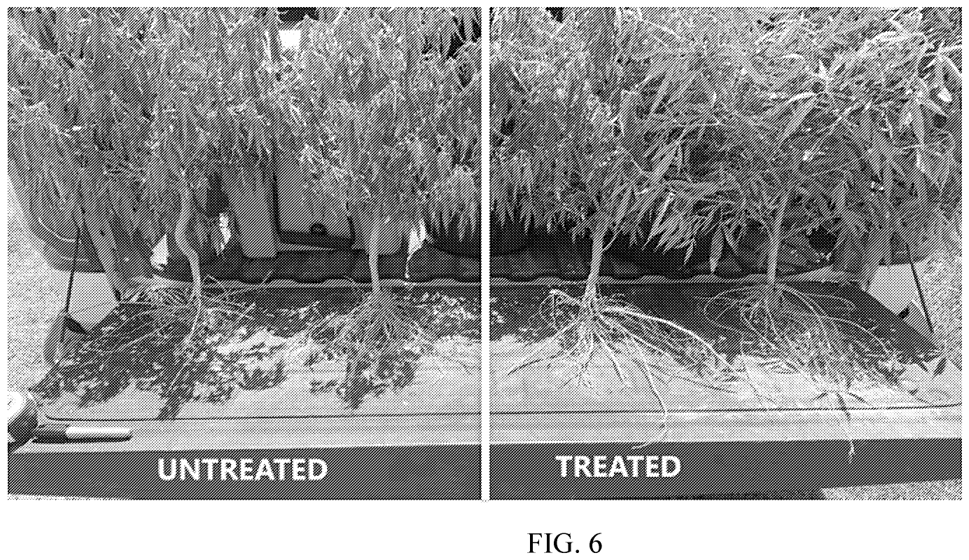

See also FIG. 6, which shows roots of treated plants that are visibly longer and thicker than untreated plants.

### Nutrient Uptake

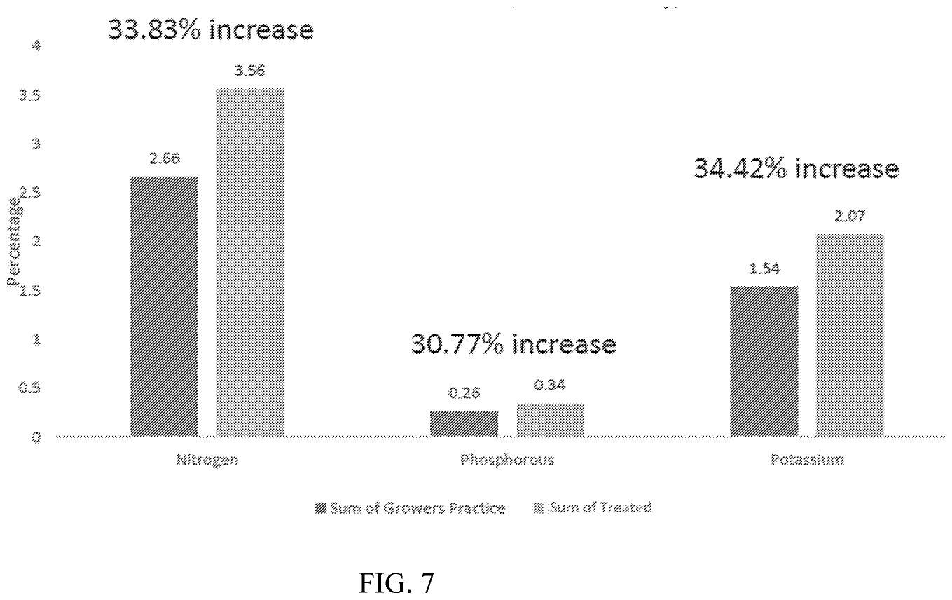

FIG. 7 shows nutrient uptake measurements of treated hemp plants from the Wake County plot, compared to grower's control hemp plants. Plant tissue and soil samples were measured for nutrient content over time via third party lab testing.

A 33.83% increase in nitrogen uptake, a 30.77% increase in phosphorous uptake, and a 34.42% increase of potassium uptake were reported in the treated hemp over the untreated. Advantageously, increased nutrient uptake means a grower can reduce the amount of fertilizer utilized on a hemp crop.

### Dry Material and CBD Yields at Harvest

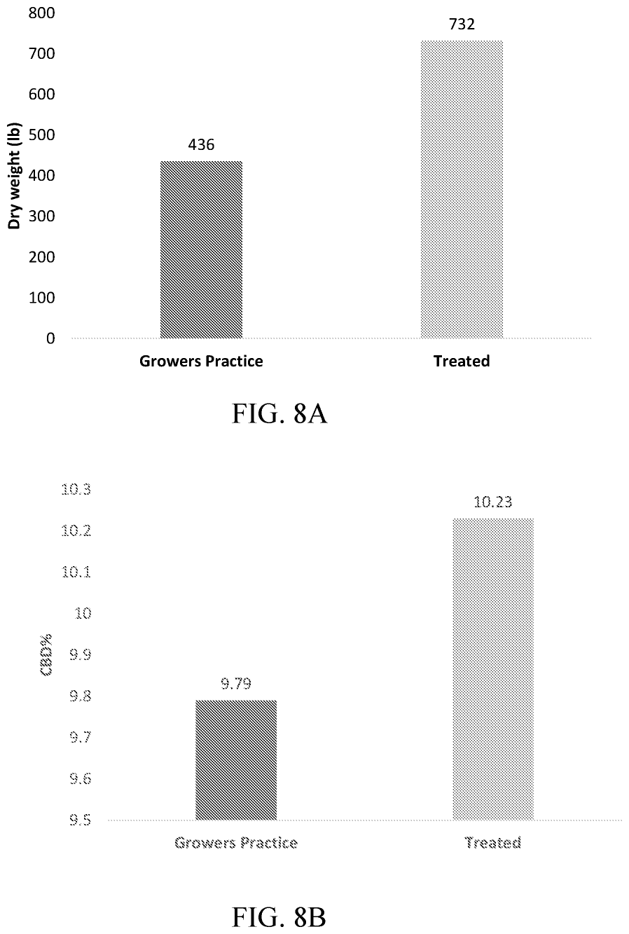

FIG. 8A shows mass of dry material (floral biomass) collected per acre of treated hemp plants harvested from the Greene County plot, compared to grower's control. Dry material was obtained by removing as much non-floral matter, such as stems and leaves, as possible from the harvested hemp plants. A 67.89% increase in pounds of dry material collected per acre was observed in the treated hemp over the untreated.

FIG. 8B shows CBD content per acre of treated hemp plants harvested from the Greene County plot, compared to grower's control hemp plants. Extraction of CBD and quantification thereof was performed by a third party. A 4.49% increase in CBD content per acre of hemp was reported in the treated hemp over the untreated.

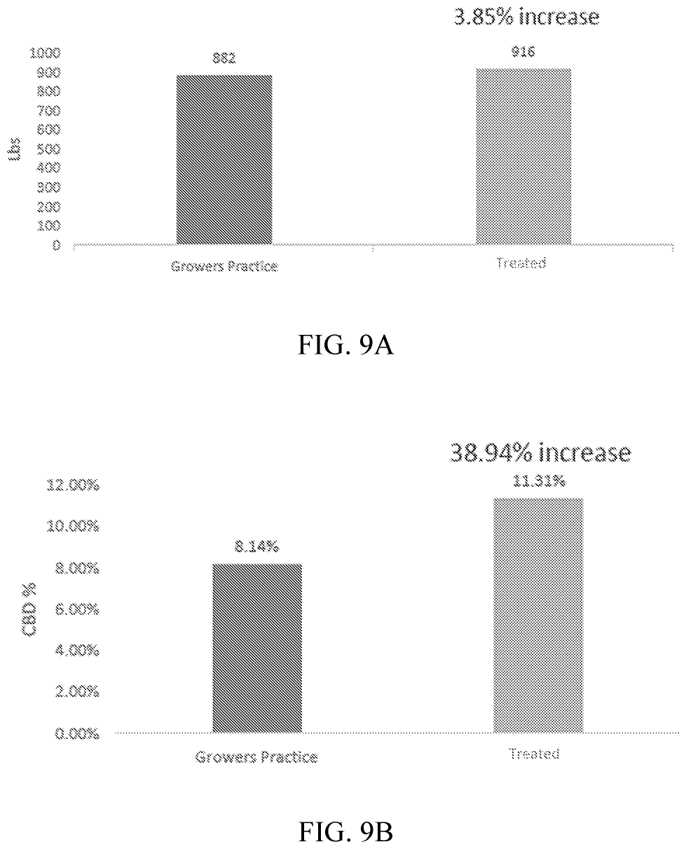

FIG. 9A shows mass of dry material (floral biomass) collected per acre of treated hemp plants harvested from the Wake County plot, compared to grower's control. A 3.85% increase in pounds of dry material collected per acre was observed in the treated hemp over the untreated.

FIG. 9B shows CBD content per acre of treated hemp plants harvested from the Wake County plot, compared to grower's control hemp plants. A 38.94% increase in CBD content per acre of hemp was reported in the treated hemp over the untreated.

1. A method of enhancing health, growth, yields and/or phytocannibinoid content of a Cannabis spp. plant, the method comprising:
applying a soil treatment composition comprising one or more soil-colonizing microorganisms, and/or a growth by-product thereof, to the plant and/or its surrounding environment, wherein the one or more microorganisms are selected from Bacillus spp., Trichoderma spp., Pleurotus spp., Saccharomyces spp., Debaryomyces spp., Lentinula spp., Wickerhamomyces spp., Starmerella spp., Meyerozyma spp., Pseudomonas spp., Pichia spp., Azotobacter spp., Frateuria spp., Myxococcus spp., and mycorrhizal fungi.

2. The method of claim 1, wherein the soil treatment composition further comprises fermentation medium in which the one or more microorganisms were cultivated.

3. The method of claim 1, wherein the soil treatment composition comprises Trichoderma harzianum or Trichoderma guizhouse.

4. The method of claim 1, wherein the soil treatment composition comprises Bacillus amyloliquefaciens.

5. The method of claim 1, wherein the soil treatment composition comprises Trichoderma harzianum and Bacillus amyloliquefaciens NRRL B-67928.

6. The method of claim 5, wherein the soil treatment composition comprises a cell count ratio of 1:4, Trichoderma to Bacillus.

7. The method of claim 1, wherein the one or more microorganisms are selected from Trichoderma harzianum, Trichoderma guizhouse, Wickerhamomyces anomalus, Pseudomonas chlororaphis, Saccharomyces boulardii, Debaryomyces hansenii, Meyerozyma guilliermondii, Bacillus amyloliquefaciens, Bacillus licheniformis, Bacillus subtilis, Myxococcus xanthus, Azotobacter vinelandii and Frateuria aurantia.

8. (canceled)

9. The method of claim 1, wherein the one or more microorganisms and/or growth by-products thereof are contacted directly with the plant's roots.

10. The method of claim 1, wherein the one or more microorganisms and/or growth by-products thereof are contacted with soil in which the plant grows.

11. (canceled)

12. The method of claim 1, wherein the one or more microorganisms and/or growth by-products thereof are applied to the plant and/or its surrounding environment using an irrigation system.

13. The method of claim 1, wherein the one or more microorganisms and/or growth by-products thereof are applied to the plant and/or its surrounding environment contemporaneously with a source of one or more nutrients selected from nitrogen, phosphorous, and potassium.

14. The method of claim 1, wherein the one or more microorganisms and/or growth by-products thereof are applied to the plant and/or its surrounding environment contemporaneously with prebiotics selected from kelp extract, fulvic acid, chitin, humate and humic acid.

15. The method of claim 1, wherein the one or more microorganisms and/or growth by-products thereof are not applied simultaneously with, or within 7 to 10 days before or after, application of benomyl, dodecyl dimethyl ammonium chloride, hydrogen dioxide/peroxyacetic acid, imazilil, propiconazole, tebuconazole, or triflumizole to the plant and/or its surrounding environment.

16. The method of claim 1, wherein the Cannabis spp. plant is selected from Cannabis sativa, Cannabis indica and Cannabis ruderalis.

17. The method of claim 1, wherein the Cannabis spp. plant is a variety of Cannabis sativa that has a tetrahydrocannabidiol (THC) content of 0.3% (dry weight) or less.

18. The method of claim 1, wherein the cannabidiol (CBD) content of the Cannabis spp. plant is increased.

19. The method of claim 1, wherein one or more qualities of the Cannabis spp. plant selected from plant height, plant width, bud size, bud count, root size, root mass, and mass of dry bud material is increased.

20. The method of claim 1, wherein an amount of fiber harvested from the Cannabis spp. plant is increased.

21. The method of claim 1, wherein nutrient absorption in the Cannabis spp. plant roots is enhanced.

22. The method of claim 1, used for enhanced production of industrial hemp-derived products selected from CBD extracts, beauty products, fibers, textiles, plastic alternatives, supplements, protein powders, and biofuels.
